(19) United States
(12) Patent Application Publication
(10) Pub. No.: US 2025/0136725 A1
(43) Pub. Date: May 1, 2025

(54) SELECTIVE DECHLORINATION OF POLY(VINYL CHLORIDE) TO FORM TUNABLE BRANCHED POLYETHYLENE OR POLYETHYLENE-POLY(VINYL CHLORIDE) BLOCK COPOLYMERS

(71) Applicant: University of Southern California, Los Angeles, CA (US)

(72) Inventors: Megan FIESER, Los Angeles, CA (US); Zachary WOOD, Los Angeles, CA (US)

(73) Assignee: University of Southern California, Los Angeles, CA (US)

(21) Appl. No.: 18/926,973

(22) Filed: Oct. 25, 2024

Related U.S. Application Data
(60) Provisional application No. 63/545,694, filed on Oct. 25, 2023.

(51) Int. Cl. C08F 8/26; C08F 299/00

(52) U.S. Cl. CPC C08F 8/26; C08F 299/00

(57) ABSTRACT

A method for dechlorinating a starting chlorinated polymer includes a step of contacting the starting chlorinated polymer with a solution that includes a cation initiator, an organosilane, and chlorinated solvent at a predetermined temperature for a sufficient time to at least partially dechlorinate the starting chlorinated polymer. Complete or partial dechlorination can be achieved depending on the reaction conditions. A block copolymer formed by the method is also provided.

### CROSS-REFERENCE TO RELATED APPLICATIONS

This application claims the benefit of U.S. provisional application Ser. No. 63/545,694 filed Oct. 25, 2023, the disclosure of which is hereby incorporated in its entirety by reference herein.

### STATEMENT REGARDING FEDERALLY SPONSORED RESEARCH OR DEVELOPMENT

This invention was made with government support under Grant No(s). DE-AC-02-07CH11358, awarded by the Department of Energy. The government has certain rights in the invention.

### TECHNICAL FIELD

In at least one aspect, the present invention is related to the dechlorination of chlorinated polymers.

### BACKGROUND

Chlorinated polymers serve a broad range of uses due to their flexibility, impact and flame resistance, durability, ductility, and hydrophobicity. (1)-(3) The most common chlorinated polymer, poly(vinyl chloride) (PVC), is the 3rd most mass-produced polymer. (4) Other chlorinated polymers, such as chlorinated PVC (CPVC) and polyethylene (CPE) (3), are produced through reactions with Cl₂ and PVC or PE, respectively, which allows for varied degrees of chlorination. (3)-(7) Despite widespread uses, chlorination is an uncontrolled radical process (FIG. 1A), (3)-(9) making it nearly impossible to produce CPE polymers with high Cl contents that also have primary structure control. For instance, desirable PVC/PE block copolymer (PVC-b-PE), (7), (10), (11) of which the primary PVC structure is retained, cannot be produced via chlorination. (3)

Block copolymers hold unique properties in comparison to random copolymers, providing key features from both polymers while also introducing new ones (FIG. 1B). (12) For example, PVC-b-PE copolymers could boast enhanced flame retardance compared to PE and lesser HCl and dioxin formation compared to PVC. (3) In particular, the addition of polar blocks with non-reactive functional groups in polyethylene has been a key target for uses in dyeability, adhesion, and miscibility. (13) The synthesis of PVC-b-PE would further be an attractive target as a compatibilizer due to the numerous multilayer films that contain PE and PVC. (14), (15)

From monomers, the synthesis of PVC-b-PE has also remained elusive. Catalysts that polymerize ethylene via a coordination mechanism will commonly be deactivated by vinyl chloride due to β-chloride elimination. (16), (17) Catalysts that can polymerize both ethylene and vinyl chloride via a radical pathway have disparate reactivity ratios for the two monomers, therefore achieving random PE-PVC sequences rather than blocks. (10)

Another route to PVC-b-PE is through dechlorination of PVC; however, notoriously difficult in a controlled manner. Many have shown great success in the efficient removal of Cl albeit at the expense of the primary structure of the end polymer product, (18)-(29) including the introduction unwanted functionalities such as double bonds. (30), (31) Conversely, hydrodechlorination with Bu₃Sn· is controlled, but does not lead to a block structure (FIG. 1C). (32)-(36)

Accordingly, there is a need for selected methods for dechlorinating chlorinated polymers.

### SUMMARY

In at least one aspect, a method for dechlorinating a starting chlorinated polymer is provided. The method includes a step of contacting the starting chlorinated polymer with a solution that includes a cation initiator, an organosilane, and chlorinated solvent at a predetermined temperature for a sufficient time to at least partially dechlorinate the starting chlorinated polymer, thereby forming a dechlorinated polymer.

In another aspect, the starting chlorinated polymer is completely dechlorinated.

In another aspect, the starting chlorinated polymer is partially dechlorinated.

In another aspect, the starting chlorinated polymer is partially dechlorinated to form a block copolymer of polyethylene and polyvinylchloride.

In another aspect, a block copolymer formed by the methods described herein is provided. The block copolymer includes a polymer block structure having a plurality of chlorinated blocks present in a first molar percent; and a plurality of polyethylene blocks present in a second molar percent. Characteristically, the polymer block structure includes at least 3 polymer blocks.

In another aspect, a poly(vinyl chloride)-b-polyethylene copolymer formed by the methods described herein is provided. The poly(vinyl chloride)-b-polyethylene copolymer has a polymer block structure including a plurality of poly(vinyl chloride) blocks present in a first molar percent; and a plurality of polyethylene blocks present in a second molar percent. Characteristically, the polymer block structure includes at least 3 polymer blocks.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1A. Examples of starting chlorinated polyethylene.

FIG. 1B. Applications of PVC-b-PE copolymers.

FIG. 1C. Random hydrodechlorination of PVC by Sn radicals.

FIG. 2. Proposed mechanism of the concerted pathway to achieve block-like dechlorination of PVC.

FIGS. 3A, 3B, 3C, 3D, and 3E. A) General reaction scheme for dechlorination of PVC by silylium ions. B) Table of results for successful dechlorination with varied branching content in the resulting PE. C) ¹H NMR of 82% dechlorinated PVC (left) vs Table 1, Entry 1 (right). Peak at 6.0 ppm is tetrachloroethane-d2. D) TGA of the resulting products (performed with a scan rate of 10° C./min. E) FT-IR of varying amounts of PVC, PE, and the resulting 82% and >99% dechlorinated products.

FIGS. 4A and 4B. A) DSC traces of PE products as a result of varying Et3SiH concentration in the reaction (FIG. 2B, entries 2-5). As Et₃SiH concentration increases, branching decreases, therefore increasing the Tₘ of the PE product. B) Proposed pathway for carbocation rearrangement.

FIG. 5. Dechlorination of a toy lizard, flexible PVC pipe, rigid PVC pipe, and used vinyl record (top-to-bottom), as measured by FT-IR spectroscopy.

FIGS. 6A, 6B, and 6C. A) Reaction conditions for PVC hydrodechlorination; B, C) FT-IR spectra of PVC dechlorination in the presence of 50 wt % PET, and 50 wt % PS (top-to-bottom): Highlights are used to label a. (cross-hatch) PS stretches, b. (angled hatch) PE stretches, and c. (horizontal hatch)C—Cl stretch.

FIGS. 7A, 7B, and 7C. A) Reaction conditions for PVC hydrodechlorination in the presence of HDPE; B) FT-IR spectra of PE product; C) DSC traces of PE products from mixed PVC/PE waste. CH₂Cl₂ soluble fraction has a Tₘ=91° C., with very little phase separation.

FIG. 8. Block hydrodechlorination of PVC.

FIGS. 9A, 9B, 9C, and 9D. Characterization of PVC-b-PE copolymers, with general reaction scheme, color system, and naming scheme. (A) ¹H NMR spectra; (B) differential scanning calorimetry (DSC); (C) ¹³C NMR spectrum of PVC₄₃-b₃₂-PE₅₇, with labeled triads (D).

FIGS. 10A, 10B, 10C, 10D, 10E, 10F, 10G, and 10H. (A) 1D slices from a 2D 1H spin diffusion spectrum taken at 5 ppm, displaying the exchange of magnetization between PVC and PE domains. (B) Spin diffusion build-up curves used to extract domain sizes. Representative WAXS (C, D, E) and SAXS (F, G, H) of select PVC-b-PE spectra acquired at 25, 120, and 150° C.

FIGS. 11A and 11B. Change in q value (A) and crystallinity (B) as the block number decreases.

FIG. 12A. Bar chart showing the number of polymer blocks versus initiator loading.

FIG. 12B. Bar chart showing the number of polymer blocks versus reaction temperature.

FIG. 12C. Bar chart showing the number of polymer blocks versus mol percent PVC.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

The term “alkyl” refers to C₁₋₂₀ inclusive, linear (i.e., “straight-chain”), branched, saturated or at least partially and in some cases fully unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The phrase “composed of” means “including” or “comprising.” Typically, this phrase is used to denote that an object is formed from a material.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

The term “residue,” as used herein, refers to the portion of a compound that remains after undergoing a chemical reaction, such as polymerization or other transformation processes. Specifically, in the context of the present invention, a residue denotes the segment of a compound that persists within the polymer structure following dechlorination, retaining its chemical integrity despite the reaction. This term also includes any structural fragment that remains as a result of incomplete reactions or as byproducts, which may function as contaminants within the polymer. Thus, residues encompass both intended components that are retained post-reaction and unintended reactants or byproducts that are not fully removed.

Throughout this application, where publications are referenced, the disclosures of these publications in their entireties are hereby incorporated by reference into this application to more fully describe the state of the art to which this invention pertains.

### Abbreviations

“CH₂Cl₂” means dichloromethane.
“Cl” means chlorine.
“CpOMe” means cyclopentanemethylether.
“DEHP” means di(2-ethylhexyl) phthalate.
“DEHT” means bis(2-ethylhexyl) terephthalate.
“DMA” means dimethylacetamide.
“DSC” means differential scanning calorimetry.
“Et₃SiH” means triethylsilane.
“fpRFDR” means finite-pulse radiofrequency-driven recoupling (related to NMR).
“GPC” means gel permeation chromatography.
“HDPE” means high-density polyethylene.
“Mn” means number-average molecular weight.
“Mw” means weight-average molecular weight.
“NMR” means nuclear magnetic resonance.
“PE” means polyethylene.
“PEPVC” means polyethylene polyvinylchloride.
“PET” means poly(ethylene terephthalate).
“PS” means polystyrene.
“PVC” means polyvinylchloride.
“RI” means refractive index.
“SAXS” means small-angle X-ray scattering.
“SEC-MALS” means size exclusion chromatography multi-angle light scattering.
“Td5%” means temperature at which 5% mass loss occurs (related to thermal degradation).
“THF” means tetrahydrofuran.
“Tm” means melting temperature.
“TGA” means thermogravimetric analysis.
“WAXS” means wide-angle X-ray scattering.

In at least one aspect, a method for dechlorinating a starting chlorinated polymer is provided. The method includes a step of contacting the starting chlorinated polymer with a solution that includes a cation initiator, an organosilane, and a chlorinated solvent (i.e., “the reaction mixture”) at a predetermined reaction temperature for a sufficient time to at least partially dechlorinate the starting chlorinated polymer (i.e., “the reaction”). The reaction can be described by the following reaction equation:

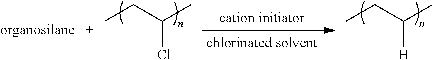

where n is the number of repeat units, typically from 500 to 5000. Advantageously, the method allows for precise control over the dechlorination process, enabling either partial or complete removal of chlorine atoms from the polymer backbone. The dechlorination can result in tunable materials, including block copolymers like PVC-b-PE, with varying degrees of polymer branching and other desirable properties. By manipulating the reaction conditions, such as temperature, time, and molar ratios, a high degree of control over the final polymer structure is achieved. In a variation, the predetermined reaction temperature is from 20 to 120° C. In some refinements, the predetermined reaction temperature is at least 20° C., 30° C., 40° C., 50° C., or 60° C. In further refinements, the predetermined reaction temperature is at most 150° C., 130° C., 120° C., 110° C., 100° C., 90° C., or 80° C.

In another aspect, the sufficient time for the reaction is at least 5 minutes. In some refinements, the sufficient time for the reaction is at least 5 minutes, 10 minutes, 1 hour, 1.5 hours, 2 hours, 3 hours, 5 hours, or 10 hours. In further refinements, the sufficient time for the reaction is at most 7 days, 3 days, 24 hours, 10 hours, 5 hours, 3 hours, 2 hours, or 1 hour. For example, sufficient time can be 10 minutes to 24 hours or more.

In another aspect, the method further includes a step of quenching the reaction Quenching can be attached by adding a small amount of water or an alcohol (such as methanol or ethanol) to the reaction mixture. This might protonate the reactive intermediates, neutralizing them and effectively stopping the reaction. In addition, the reaction can be quenched by chilling, for example, in an ice bath.

In another aspect, the method further includes a step of drying the dechlorinated polymer. Polymers can be dried after dechlorination using several methods, depending on their sensitivity to heat and the type of solvent used. Common methods include vacuum drying, which removes solvent by applying low pressure and gentle heat, and rotary evaporation, where the polymer solution is heated under reduced pressure to evaporate the solvent efficiently. Air drying or using a desiccator may also be used for less sensitive polymers. These techniques help ensure complete solvent removal while minimizing the risk of polymer degradation.

In another aspect, the starting chlorinated polymers can exhibit a range of weight-average molecular weights (Mw), reflecting the variability in polymer chain lengths. Generally, the Mw for the starting chlorinated polymers (e.g., poly(vinyl chloride)) materials ranges from approximately 62 kg/mol to 233 kg/mol. This range indicates a broad distribution of polymer chain sizes, with different samples having varying proportions of shorter and longer polymer chains. The number-average molecular weight (Mn) for these samples falls between 35 kg/mol and 99 kg/mol, providing a detailed view of the molecular weight characteristics of the starting chlorinated polymers. The difference between Mn and Mw provides insight into the distribution of polymer chain lengths, indicating a mix of shorter and longer chains in the samples.

In another aspect, the cation initiator is [Ph₃C][B (C₆F₅)₄]. In a refinement, the cation initiator is present in an amount from about 0.1 to 5 mol % of a sum of the cation initiator, the starting chlorinated polymer, and the organosilane. In some refinements, the cation initiator is present in an amount of at least 0.1 mol %, 0.5 mol %, 1 mol %, 2 mol %, or 3 mol % of the sum of the cation initiator, the starting chlorinated polymer, and the organosilane. In further refinements, the cation initiator is present in an amount of at most 5 mol %, 4 mol %, 3 mol %, 2 mol %, or 1.5 mol % of the sum of the cation initiator, the starting chlorinated polymer, and the organosilane

In another aspect, the organosilane is a trialkylsilyl hydride. In a refinement, the trialkylsilyl hydride is described by the following formula:

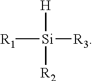

wherein R₁, R₂, and R₃ are each independently C₁₋₈ alkyl. An example of a useful organosilane is Et₃SiH. In another aspect, a molar ratio of the organosilane to the starting chlorinated polymer is from 0.1 to 15. In some refinements, the molar ratio is at least 0.1, 0.5, 1, 2, 3, or 5. In further refinements, the molar ratio is at most 20, 15, 12, 10, 8, or 6.

In another aspect, the chlorinated solvent is dichloromethane (CH₂Cl₂). Other potential chlorinated solvents include chloroform (CHCl₃), 1,2-dichloroethane (C₂H₄Cl₂), carbon tetrachloride (CCl₄), tetrachloroethylene (C₂Cl₄), and chlorobenzene (C₆H₅Cl).

In another aspect, the starting chlorinated polymer is a chlorinated polyolefin. In a refinement, the starting chlorinated polymer is polyvinyl chloride (PVC) or polyvinylidene chloride (PVDC). As described in more detail below, the method advantageously allows for the controllable removal of chlorine from PVC at mild temperatures, providing a practical approach to dechlorinating these polymers while maintaining control over the process conditions.

In another aspect, the method is capable of removing essentially all the chlorine from PVC to produce polyethylene (PE). In a refinement, the method is capable of fully removing chlorine from PVC, converting it into polyethylene (PE) with over 99.9% dechlorination. Depending on the reaction conditions, PE materials with varying degrees of branching and crystallinity can be synthesized, allowing precise control over the polymer's thermal and mechanical properties. Experimental data shows that by adjusting the concentration of triethylsilane (Et₃SiH) from 0.25 to 6 equivalents and the initiator loading from 0.5 to 1.6 mol %, the degree of branching in the PE can be varied significantly. For example, higher Et₃ SiH concentrations favor hydride transfer and reduce branching, resulting in a more crystalline material with a melting temperature (Tm) as high as 93° C., compared to a lower Tm of 51° C. for more branched PE. This method also demonstrated robustness in handling commercial PVC samples containing additives, achieving near-complete dechlorination even in complex waste streams. The flexibility of the process allows for the production of PE materials tailored for specific applications, such as higher-density, highly crystalline PE for durable goods or branched, more flexible PE for applications requiring elasticity. This ability to customize the polymer's structure and properties makes the method highly versatile for addressing various industrial and recycling needs.

In another aspect, the method is useful when considering PVC that enters the PE recycling stream, as these impurities can severely disrupt the processing of PE waste. Using this method, PVC can be converted to PE without the generation of corrosive or toxic byproducts, allowing the entire PE batch to continue in the recycling process without disruption. This technology also works with a variety of PVC items with common plasticizers such as phthalates, which are added sometimes up to 50 wt % to PVC items to give desired properties. Furthermore, it has been demonstrated that this process works with PVC in the presence of PE waste, mimicking a real example of what a recycling center might see.

In another variation, the method provides selective dechlorination of PVC, facilitating the formation of polyethylene (PE) blocks and enabling the synthesis of PVC-b-PE block copolymers. The reaction can be described by the following formula:

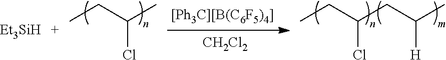

This method allows precise control over the dechlorination process, tailoring the number, length, and arrangement of the blocks. By adjusting reaction conditions, such as the concentration of triethylsilane (Et₃SiH) from 0.25 to 10 equivalents relative to PVC, the block copolymers can be fine-tuned for desired structural properties. Advantageously, higher concentrations of Et₃SiH favor the formation of longer PE blocks and reduce the occurrence of undesired side reactions, such as bond scission or alkyl branching. For example, with Et₃SiH at 0.5 mol %, multiblock copolymers with alternating PVC and PE segments were achieved, confirmed by ¹H and ¹³C NMR analysis. The block number and length are further controllable by modifying the temperature and initiator concentration, allowing the creation of copolymers with enhanced properties, including improved phase separation and crystallinity. These PVC-b-PE copolymers exhibit unique properties that make them ideal for applications such as adhesives, compatibilizers, and thermoplastic elastomers, where tunable mechanical strength, flexibility, and thermal resistance are required. The block number and length are further controllable by modifying the temperature (from 40° C. to 120° C.) and initiator concentration (from 0.5 to 1.6 mol %). Higher temperatures and initiator concentrations lead to shorter block lengths and increased crystallinity, while lower temperatures and reduced initiator concentrations allow for fewer but longer blocks. This flexibility enables the creation of copolymers with enhanced properties, including improved phase separation, thermal stability, and crystallinity, as demonstrated by differential scanning calorimetry (DSC) and small-angle X-ray scattering (SAXS). These PVC-b-PE copolymers exhibit unique properties that make them ideal for applications such as adhesives, compatibilizers, and thermoplastic elastomers, where tunable mechanical strength, flexibility, and thermal resistance are required.

In another aspect, a block copolymer formed by the methods set forth above is provided. The block copolymer has a polymer block structure that includes a plurality of chlorinated blocks present in a first molar percent; and a plurality of polyethylene blocks present in a second molar percent. Characteristically, the polymer block structure includes at least 3 polymer blocks, e.g., alternating blocks of chlorinated blocks and polyethylene blocks. The block copolymer can be represented by the following formula:

PC_{X}-b_{N}-PE_{Y}.

wherein:
PC is a repeat unit for a chlorinated block;
PC is a repeat unit for a polyethylene block (e.g., —CH₂CH₂—);
X is the mol percent of the repeat units for the chlorinated blocks;
Y is the mol percent of the repeat units for the polyethylene blocks;
N is the total number of polymer blocks which is typically at least 3.

In a variation, the first molar percent (X) is from 10 to 90 molar percent and the second molar percent (Y) is from 90 to 10 molar percent. In some refinements, the first molar percent is at least 10, 20, 30, 40, or 50 molar percent. In further refinements, the first molar percent is at most 90, 80, 70, 60, or 50 molar percent. Similarly, the second molar percent can be at least 10, 20, 30, 40, or 50 molar percent. In further refinements, the second molar percent can be at most 90, 80, 70, 60, or 50 molar percent. These ranges provide flexibility in adjusting the proportion of the chlorinated blocks in the block copolymer, allowing for tunable material properties based on the desired application. Typically, the sum of the first molar percent and the second molar percent from about 98 to 100% mol percent. In some refinements, the sum is at least 98.0, 98.5, 99.0, 99.5, or 99.8 mol percent. In further refinements, the sum is at most 100, 99.9, 99.8, 99.7, or 99.5 mol percent. This ensures that the combined molar percentages of the chlorinated blocks and polyethylene blocks in the block copolymer approach or reach full polymer composition, with minimal deviation from the intended structure.

In another aspect, the block copolymer can include residues of the starting materials in a residue mole percent. Typically, the residue mole percent is less than 2 molar percent. In a refinement, the residue mole percent is less than or equal to, in increasing order of preference, 2 molar percent, 1.5 molar percent, 1 molar percent, 0.5 molar percent, 0.1 molar percent, 0.01 molar percent, or 0 molar percent. In a refinement, the block copolymer includes residues of a cation initiator and/or an organosilane percent, each present in an amount of less than 1 molar percent. In some refinements, the block copolymer includes residues of a cation initiator and/or an organosilane percent, each present in an amount of less than or equal to, in increasing order of preference, 1 molar percent, 0.5 molar percent, 0.1 molar percent, 0.01 molar percent, or 0 molar percent. In this refinement, the sum of the first molar percent, the second molar percent, and the residue mole percent is from about 99 to 100 mol percent. In some refinements, this sum is at least 99.0, 99.2, 99.4, 99.6, or 99.8 mol percent. In further refinements, this sum is at most 100, 99.9, 99.8, 99.7, or 99.6 mol percent. This range ensures that the combined molar percentages of the chlorinated blocks, polyethylene blocks, and any residues approach full polymer composition, with minimal amounts of residue, providing a highly pure and well-defined block copolymer.

In another aspect, the polymer block structure includes from 3 to 100 polymer blocks, i.e., a combination of chlorinated blocks and polyethylene blocks. In some refinements, the polymer block structure includes at least 3, 5, 10, 15, 20, or 25 polymer blocks. In further refinements, the polymer block structure includes at most 100, 90, 80, 70, or 60 polymer blocks.

A specific example of a block copolymer is a poly(vinyl chloride)-b-polyethylene block copolymer. The poly(vinyl chloride)-b-polyethylene includes a polymer block structure having a plurality of poly(vinyl chloride) blocks present in a first molar percent and a plurality of polyethylene blocks present in a second molar percent. Characteristically, the polymer block structure includes at least 3 polymer blocks, e.g., alternating blocks of poly(vinyl chloride) and polyethylene blocks, e.g., alternating blocks of poly(vinyl chloride) and polyethylene blocks. The poly(vinyl chloride)-b-polyethylene block copolymer can be represented by the following formula:

PVC_{X}-b_{N}-PE_{Y}.

wherein:
PVC is a repeat unit for a poly(vinyl chloride) block;
PC is a repeat unit for a polyethylene block (e.g., —CH₂CH₂—);
X is the mol percent of the repeat units for the poly(vinyl chloride) blocks;
Y is the mol percent of the repeat units for the polyethylene blocks;
N is the total number of polymer blocks which is typically at least 3.

In a variation, the first molar percent (X) is from 10 to 90 molar percent and the second molar percent (Y) is from 90 to 10 molar percent. In some refinements, the first molar percent is at least 10, 20, 30, 40, or 50 molar percent. In further refinements, the first molar percent is at most 90, 80, 70, 60, or 50 molar percent. Similarly, the second molar percent can be at least 10, 20, 30, 40, or 50 molar percent. In further refinements, the second molar percent can be at most 90, 80, 70, 60, or 50 molar percent. As set forth above, the sum of the first molar percent and the second molar percent from about 98 to 100% mol percent. In some refinements, the sum is at least 98.0, 98.5, 99.0, 99.5, or 99.8 mol percent. In further refinements, the sum is at most 100, 99.9, 99.8, 99.7, or 99.5 mol percent. This ensures that the combined molar percentages of the chlorinated blocks and polyethylene blocks in the block copolymer approach or reach full polymer composition, with minimal deviation from the intended structure.

In another aspect, the poly(vinyl chloride)-b-polyethylene block copolymer can include residues of the starting materials in a residue mole percent. Typically, the residue mole percent is less than 2 molar percent. In a refinement, the residue mole percent is less than or equal to, in increasing order of preference, 2 molar percent, 1.5 molar percent, 1 molar percent, 0.5 molar percent, 0.1 molar percent, 0.01 molar percent, or 0 molar percent. In a refinement, the block copolymer includes residues of a cation initiator and/or an organosilane percent, each present in an amount of less than 1 molar percent. In some refinements, the block copolymer includes residues of a cation initiator and/or an organosilane percent, each present in an amount of less than or equal to, in increasing order of preference, 1 molar percent, 0.5 molar percent, 0.1 molar percent, 0.01 molar percent, or 0 molar percent. In this refinement, the sum of the first molar percent, the second molar percent, and the residue mole percent is from about 99 to 100 mol percent. In some refinements, this sum is at least 99.0, 99.2, 99.4, 99.6, or 99.8 mol percent. In further refinements, this sum is at most 100, 99.9, 99.8, 99.7, or 99.6 mol percent. This range ensures that the combined molar percentages of the chlorinated blocks, polyethylene blocks, and any residues approach full polymer composition, with minimal amounts of residue, providing a highly pure and well-defined block copolymer.

In another aspect, the polymer block structure includes from 3 to 100 polymer blocks (i.e., N is from 3 to 100), i.e., a combination of poly(vinyl chloride) blocks. In some refinements, the polymer block structure includes at least 3, 5, 10, 15, 20, or 25 polymer blocks. In further refinements, the polymer block structure includes at most 100, 90, 80, 70, or 60 polymer blocks. Similarly, in some refinements, Y is at least 10, 20, 30, 40, or 50 molar percent.

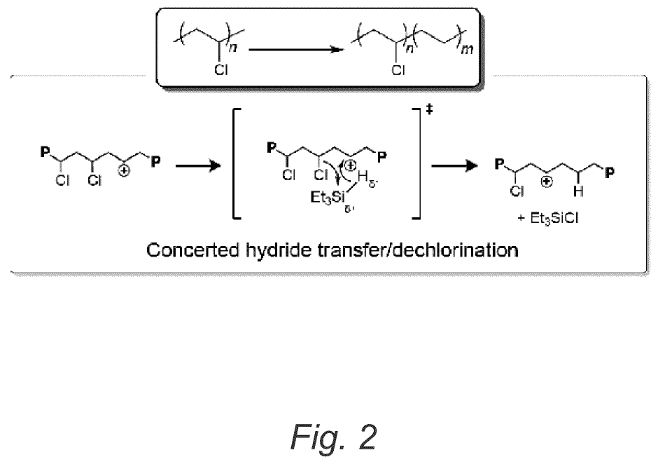

It should be appreciated that partial reduction of PVC to PVC/PE has been achieved before in the literature with Bu₃SnH reagents, however the Cl atoms were dechlorinated randomly along the polymer backbone. (10) Therefore, the chemistry of the methods provided herein gives interesting fundamental insight into the hydrodechlorination of substrates that have multiple C—Cl bonds nearby each other. It is hypothesized that due to our hydrodechlorination pathway proceeding through cationic intermediates. It is plausible that concerted dechlorination mechanism (FIG. 2) is occurring in the present methods. In contrast, reduction of PVC with Bu₃SnH undergoes a stepwise mechanism (due to a radical pathway), leading to random dechlorination. Knowledge of the underlying mechanistic pathway will give a greater understanding of how to finely tune this invention to achieve targeted polymer morphologies. Table 1.1 provides various conditions leading to partial dechlorination of PVC.

The following examples illustrate the various embodiments of the present invention. Those skilled in the art will recognize many variations that are within the spirit of the present invention and scope of the claims.

### 1. Partial Dechlorination of PVC

Table 1 provides various conditions leading to partial dechlorination of PVC.

TABLE 1.1
Partial dechlorination conditions.

| | | | | |
|---|---|---|---|---|
| EtsSiH 0.25-6 equiv. | + | 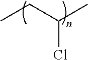 | 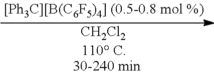 | 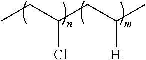 |

| | | | | | % Cl loss | | |
|---|---|---|---|---|---|---|---|
| | Tᵣₓₙ | | Init. | Eₜ₃SiH | (¹H | Tₘ^{e} | T_{g}^{f} |
| Entry | (° C.) | Time | mol %^{a} | equiv.^{b} | NMR)^{c} | (° C.)^{d} | (° C.)^{d} |
| 1 | 110 | 2 h | 0.8 | 0.25 | 8 | — | 73 |
| 2 | 110 | 2 h | 0.8 | 0.50 | 33 | — | 53 |
| 3 | 110 | 2 h | 0.8 | 0.90 | 76 | 44 | — |
| 4 | 110 | 4 h | 0.8 | 0.50 | 43 | — | 67 |
| 5 | 110 | 4 h | 0.8 | 0.90 | 84 | 48 | — |
| 6 | 110 | 30 min | 0.8 | 6 | 12 | -— | 70 |
| 7 | 110 | 30 min | 0.5 | 6 | 54 | 65 | −15,−95 |
| 8 | 110 | 30 min | 0.8 | 3.6 | 42 | 60 | 4 |

^{a}Initiator loading referenced to PVC mol %.
^{b}Et₃SiH loading in reference to PVC equivalence.
^{c}Calculated by ¹H NMR at 80° C. in tetrachloroethane-d₂.
^{d}DSC performed at a scan rate of 10° C./min.

### 2. Conversion of Waste Poly(Vinyl Chloride) to Tunable Branched Polyethylene Products Mediated by Silylium Ions

### 2.1 Dechlorination of PVC to Tunable PE Products Using Silylium Ions

A potential system in which PVC could be fully dechlorinated to PE-like products, while also being purified of any reactants and matching the thermal properties of PE was investigated by the experiments in this section. A recent report on using silylium ions generated in situ to rapidly dechlorinate PVC (with a reaction time of 5 minutes) introduced a new strategy to convert PVC waste into polymers, specifically poly(ethylene-co-styrene) copolymers, with potential for higher-value applications⁸. To form these copolymers, tandem hydrodechlorination/Friedel-Crafts reactivity was proposed. Although full dechlorination was confirmed by 1H nuclear magnetic resonance spectroscopy (NMR), the resulting polymers could not be recycled with PE due to the presence of the poly(styrene) (PS) moiety. Given that silylium ions were able to rapidly dechlorinate PVC in arene solvents, it was questioned whether the reaction conditions could be modified to fully dechlorinate PVC to PE as a proof of concept for mixed waste treatment before recycling. Experiments demonstrating the formation of tunable PE products, generated from the complete or near-complete dechlorination of PVC in as little as two hours, even at room temperature is presented below. The reaction for this this method can be described by:

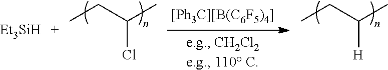

where n is the number of repeat units, typically from 500 to 5000. These experiments identified that adjusting reaction conditions could alter the production of PE with tunable degrees of branching, and consequently, thermal properties, suggesting this process can work in the presence of different PE waste streams to yield products with customizable thermal properties. The method using silylium ions proved remarkably robust against common plasticizers such as phthalate esters. Additionally, it demonstrated the dechlorination of PVC in the presence of other plastics, serving as a proof of concept for repurposing PVC-contaminated waste streams.

Additional details for this section are found in Zachary A. Wood, Eunice C. Castro, Angelyn N. Nguyen, Megan E. Fieser, Conversion of waste poly(vinyl chloride) to branched polyethylene mediated by silylium ions. Electronic supplementary information (ESI) available. See DOI: https://doi.org/10.1039/d4sc00130c, Chemical Science, Volume 15, Issue 23, 2024, Pages 8766-8774, ISSN 2041-6520; the entire disclosure of which is hereby incorporated by reference in its entirety.

### 2.2 Complete PVC Dechlorination

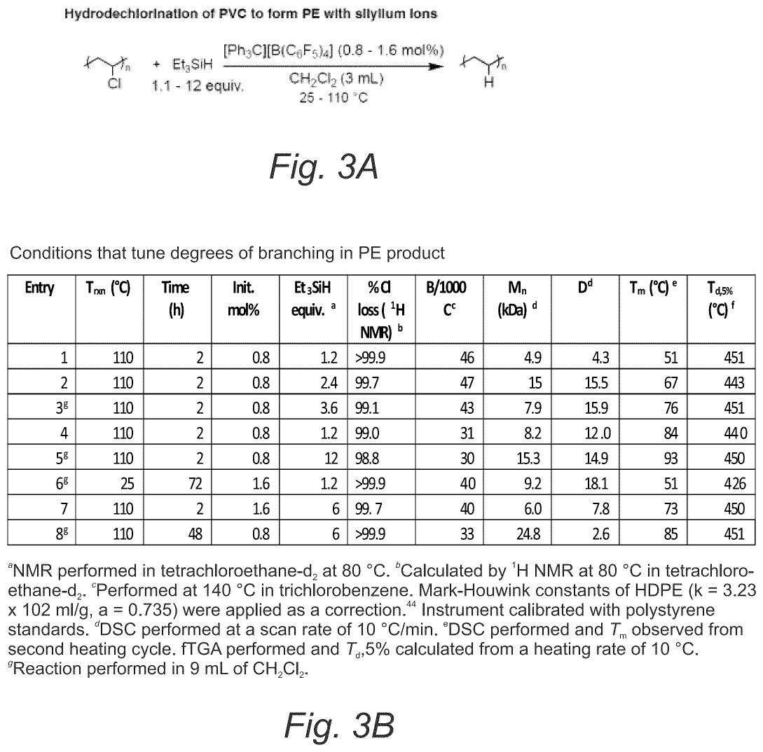

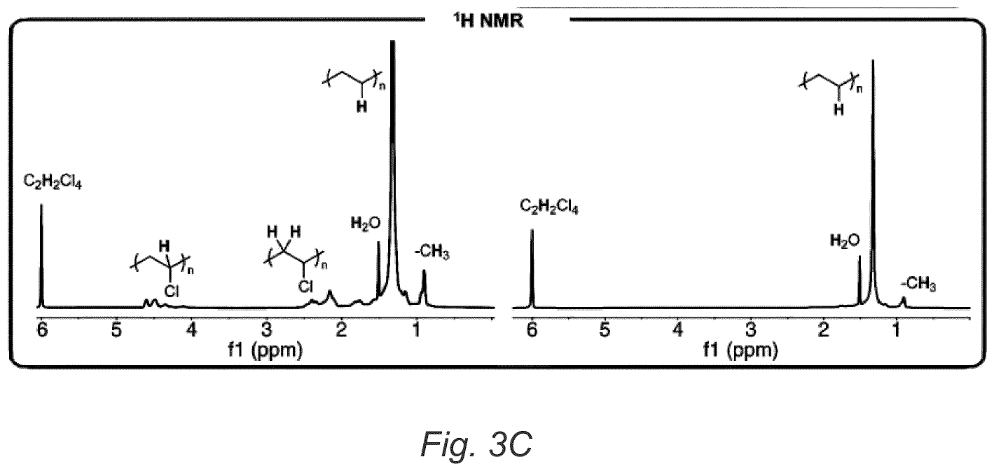

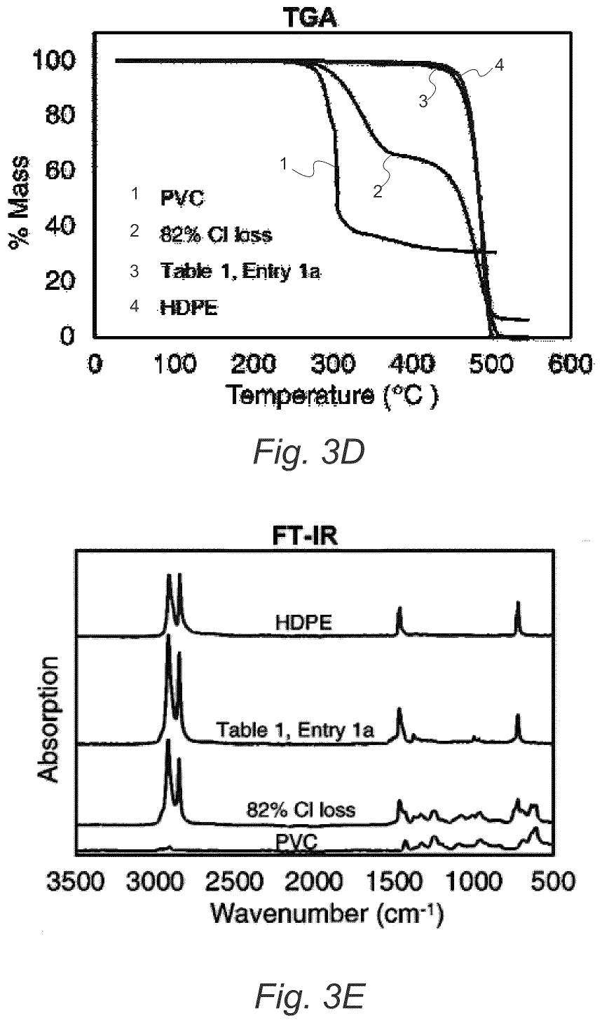

Solvents were first screened that would enable hydrodechlorination without the presence of Friedel-Crafts reactivity. Initial experiments were performed with 0.5 mol % of an initiator ([Ph₃C][B(C₆F₅)₄]) and 1.1 equivalence of Et₃SiH. Tetrahydrofuran (THF), dimethylacetamide (DMA), and cyclopentanemethylether (CpOMe) were all chosen first due to precedence for their ability to solvate PVC. THF did not show any conversion of PVC to PE, which is unsurprising due to [Ph₃C][B (C₆F₅)₄] being able to ring-open polymerize THF.21 DMA and CpOMe did not show any dechlorination, which is proposed to be due to the heteroatoms present forming strong interactions with silylium ions, rendering the catalyst in an unreactive dormant state. Dechlorination in the presence of dichloromethane (CH₂Cl₂), at 110° C., showed >99% dechlorination after 18 hrs (by 1H Nuclear Magnetic Resonance (NMR), see SI for details). Gratifyingly, this reaction was performed on the benchtop with no drying needed of the PVC, Et₃SiH, or CH₂Cl₂ used for the reaction. This is surprising given the highly Lewis-acidic nature of the presumed silylium ions being generated, and past researchers noting the necessity to rigorously dry all solvents and reagents. Further investigation of the ¹H NMR shows the C—H resonance of the C—Cl bond still present and integrating it (relative to the CH2 repeat unit of the PE repeat unit) gives a 99.0% dechlorination value. Elemental analysis was also performed on the resulting PE product, in addition to pure high-density polyethylene (HDPE) from Sigma Aldrich, but even experimental data from pure PE was not in agreement with theoretical. Therefore, ¹H NMR was primarily used to determine the percent dechlorination in the resulting PE products from PVC. For these experiments, full dechlorination is defined as >99.9%, which is when no C—H associated with the C—Cl of PVC can be observed in the ¹H NMR. A combination of ¹H NMR, FT-IR, and thermogravimetric analysis (TGA) can all be used to distinguish chlorine still remaining in the polymer product (FIG. 3).

To ensure full dechlorination, the reaction was performed for 2 hours in slight excess of Et₃SiH (1.2 equivalence to PVC) and a higher initiator loading (0.8 mol % vs. 0.5 mol %) to achieve no observable ¹H NMR resonance ˜4.00 ppm (in d₂-tetrachloroethane) (FIG. 3B, Entry 1). A 95% yield is achieved for this conversion of PVC to PE, which is a significant increase from other reports only able to achieve up to 69% yield of dechlorinated oils and waxes that are rid of Cl.

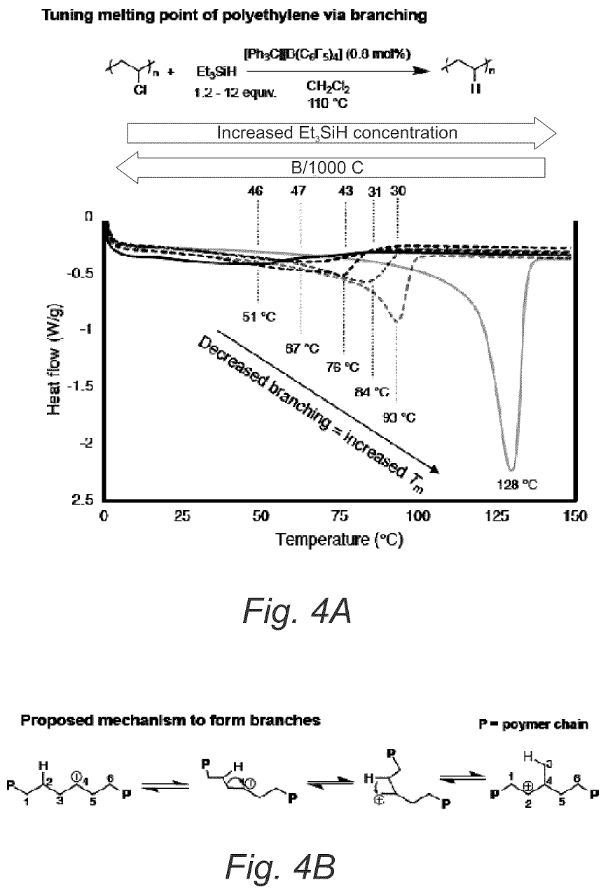

¹H NMR analysis indicates 46 branches per 1000 carbons (46/1000 C), which is much higher than what PVC is suggested to have (˜2-4/1000C) based on prior reports. It is proposed this can be due to carbocation rearrangement of the PE chain, which would produce methyl(and other alkyl) branches along the backbone (FIG. 4B). Hydrodechlorination using silylium ions on small molecules have exhibited carbocation rearrangement, supporting this can happen on larger molecules, such as organic polymers. ¹H NMR also indicates the minor presence of aromatic and alkene environments at 0.3% and 0.2%, respectively. Alkene resonances can appear through chain scission events caused by carbocation rearrangements, and aromatic resonances can appear through further degradation involving the double bonds. Chain scission is further supported by the final polymer molar mass (Mn) of 4.9 kDa, acquired through high-temperature gel permeation chromatography (GPC), which is lower than the theoretical molar mass of 20.4 kDa if dechlorination but no chain scission of PVC occurred. Chain scission is also consistent with the increase in dispersity (D) (4.3 from the original, 1.7 from the PVC starting material). Scrambling of the carbocation between polymer chains is also possible. ²⁹Si and ¹⁹F NMR spectroscopy were performed to confirm no contamination of the initiator and any biproducts of the reaction. FT-IR confirms near full dechlorination as the vibration ˜600 cm-1 disappears. Weak C═C frequencies ˜1500 cm-1 are also present in the FT-IR spectrum, supporting the chemical shifts seen in ¹H NMR. Vibrations of branching in PE are also consistent with those report in past literature.45 To confirm the branching content, differential scanning calorimetry (DSC) analysis was performed to measure the melting point of the PE product (FIGS. 3B and 4A). The resulting PE product has a melting point (Tₘ)=51° C., which agrees with a relatively high branching content calculated by ¹H NMR. For comparison, HDPE (Sigma Aldrich) has a Tₘ=128° C. The melting point depression is due to the short chain branches (which are likely placed randomly in this case) causing the PE to become less crystalline and more amorphous. When compared to reports with primarily methyl branching on the PE backbone, the Tₘ is lower than expected (see SI for details). This is likely due to more than just methyl branches occurring in the resulting PE chain.

Additionally, the resulting PE product displays a Td,5%=451° C., which is near virgin HDPE from Sigma Aldrich (Td,5%=457° C.) and matches that from other literature reports for PE polymers (FIG. 3E). A sample with 82% dechlorination by ¹H NMR gives a Td,5%=302° C., which is noticeably lower than the sample with >99.9% dechlorination. These data indicate that the Td,5% of PE from PVC is also a measurement that can be used to see if Cl content is still in the polymer, but this does not seem to be as sensitive to minute Cl content amounts that are detectable by ¹H NMR. This is further shown by a sample that reached 98.8% dechlorination by ¹H NMR, yet had a Td,5%=450° C.

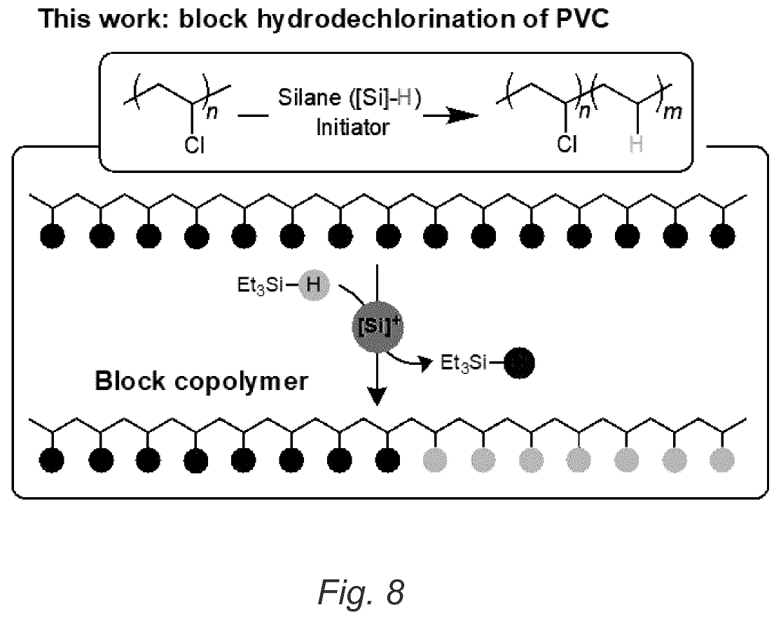

To tune the degree of branching in the resulting PE, it is proposed that performing the reaction in excess Et₃SiH would favor hydride transfer from Et₃SiH rather than carbocation rearrangement (FIG. 4). Indeed, as the Et₃SiH loading was increased (FIG. 3B, entries 2-5), the degree of branching decreased. Satisfyingly, the branch content can be lowered to 30/1000 C (FIG. 8B, Entry 6. The resulting PE displays a Tₘ of 93° C. Lowering the temperature of the reaction was also tried (FIG. 3, Entry 6). However, lowering the temperature only decreased branching slightly, while giving a similar Tₘ to a reaction performed at 110° C. (Tₘ=51° C. for both reactions). When the reaction was conducted in hexanes, full dechlorination was not achieved. Generally, it is likely that it is difficult to overcome the probability of carbocation rearrangement due to it likely existing in a rapid equilibrium, even at lower temperatures. Any reagents that can trap carbocations (e.g., nucleophiles) will also likely trap the highly Lewis-acidic silylium ions, rendering the reaction dormant.

The initiator loading was also increased from 0.8 mol % to 1.6 mol %, and the branching content was subsequently increased from 31 to 40 B/1000 C (FIG. 3B, entry 7). This increase in branching could be due to more cations being generated in solution, leading to more rearrangement. Dilution of the reaction from FIG. 3B, entry 4, did not change the branching in the product and therefore the Tₘ was the same (FIG. 3B, entry 8).

However, the dilute conditions did lead to a higher molar mass product with lower dispersity, suggesting the dilution prevents chain scission reactivity between polymer chains. The ¹H NMR spectrum indicates no arene or alkene environments, further supporting that no chain scission occurs in more dilute conditions.

The influence of molar mass (Mn) on the dechlorination, branching, and chain scission was evaluated next. Using optimized reaction conditions from FIG. 3B, entry 4, PVC samples with molar masses ranging from 36 kg/mol-99 kg/mol resulted in similar degrees of branching (˜50/1000 C), and therefore thermal properties of the resulting PE product. A similar percent dechlorination was observed for all molar masses of the PVC in 2 hours, suggesting the method is not affected by the molar mass of the polymer. This was surprising, as it was anticipated that the higher molar mass polymers would be more difficult to solubilize either as PVC or as dechlorination occurs. GPC analysis revealed evidence of chain scission reactions occurring for all PVC materials, with polymer products all having similar molar masses around 10 kDa. This is an alternative to the proposition that the higher the molar mass of the PVC starting material was, the higher the molar mass of the PE product would be.

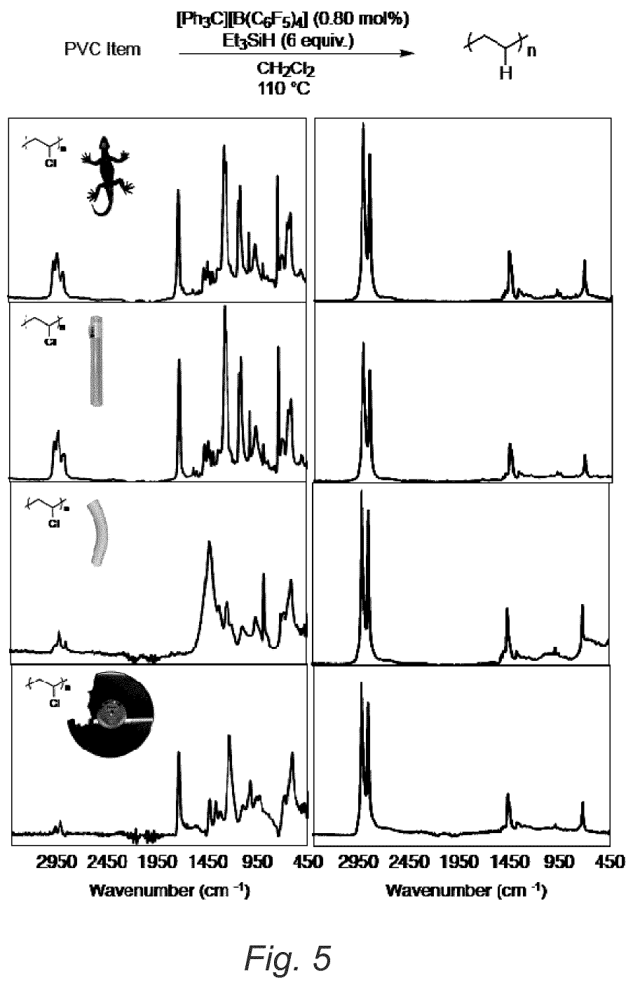

In most cases, additives are considered a concern for the lifetime or stability of a catalyst. PVC is rarely used in its pure form commercially, as plasticizers (sometimes >50 wt % of the product) are added to give PVC properties for different applications. In particular, many additives have polar functional groups that could react with the silylium cations, triethyl silane or the trityl initial catalyst. Therefore, reactions were performed on four commercial items that varied in appearance and flexibility (including a colorful toy lizard, rigid PVC plumbing pipe, flexible and colorless PVC tubing, and a vinyl record). Reactions were performed with the four items used without purification, other than to break the items into smaller pieces in a coffee grinder or with scissors. Using the same optimized conditions from FIG. 3B, entry 4, near complete hydrodechlorination was realized for all four items (Table 2.1 and FIG. 5).

TABLE 2.1
Result of silylium chemistry with commercial PVC items.

| | | |
|---|---|---|
| PVC Item | 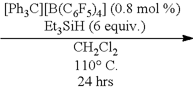 | 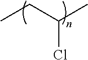 |

| | | % Cl loss | | | | | |
|---|---|---|---|---|---|---|---|
| | | (¹H | B/1000 | Mn | | Tm | Td,5% |
| Entry | Item | NMR) | C^{b} | (kDa)^{c} | Ð^{c} | (° C.)^{d} | (° C.)^{e} |
| 1 | Toy Lizard | 99.9 | 51 | 9.5 | 2.1 | 65 | 431 |
| 2 | Extracted Toy Lizard | 99.7 | 34 | 26.7 | 4.1 | 83, 102 | 451 |
| 3 | Rigid PVC Pipe | 98.3 | 43 | 6.9 | 2.4 | 82 | 434 |
| 4 | Soft PVC Pipe | 99.2 | 63 | 4.6 | 3.2 | 42 | 386 |
| 5 | Vinyl record | >99.9 | 60 | 9.5 | 2.1 | 69 | 437 |
| 6 | Extracted Vinyl Record | 99.4 | 55 | 4.1 | 2.3 | 76 | 441 |
| 7 | Pure PVC | 99 | 31 | 8.2 | 12 | 84 | 440 |

^{a}NMR performed in tetrachloroethane-d₂ at 80 ºC.
^{b}Calculated by ¹H NMR at 80° C. in tetrachloroethane-d₂.
^{c}Performed at 140° C. in trichlorobenzene. Mark-Houwink constants of HDPE (k = 3.23 × 102 ml/g, a = 0.735) were applied as a correction.⁴⁴ Instrument calibrated with polystyrene standards.
^{d}DSC performed at a scan rate of 10° C./min.
^{e}DSC performed and Tm observed from second heating cycle.
^{f}TGA performed and T_{d},5% calculated from a heating rate of 10° C.
^{g}From Figure 3B, Entry 4.

As seen in FIG. 5, all 4 PVC items were converted to PE-like products, based on FT-IR spectroscopy, with all items reaching >98% dechlorination by ¹H NMR. This result was particularly exciting, as many of the PVC items showed a vibration at 1715 cm⁻¹, which is indicative of a carbonyl stretching mode of an ester. For example, DEHP (Di(2-ethylhexyl) phthalate) exhibits a carbonyl absorption also at 1725 cm⁻¹. ¹H NMR analysis (of the soluble fraction of the flexible PVC pipe) reveals one aromatic environment, indicative of a plasticizer more like bis(2-ethylhexyl) terephthalate (DEHT). As mentioned before, highly Lewis-acidic silylium ions are likely being formed in this reaction, so the observation that the reaction is not halted by the interaction of carbonyl and ester moieties of any plasticizers is unexpected. This is even more surprising given the fact that all the PVC items used in FIG. 5 were not purified or dried before the dechlorination, therefore, even likely retaining moisture. Surprisingly, the vinyl record showed no remaining Cl in NMR or FT-IR studies. Although rigid PVC pipe showed the least dechlorination (98.3%), the ability to achieve that high dechlorination was surprising due to the large amount of additives and low solubility of this material. These results show that silylium ions are surprisingly robust to plasticizers and additives in commercial PVC items.

While near full dechlorination of almost all PVC items in FIG. 5 was achieved, the resulting polyethylene products differed quite greatly. Depending on the item selected, there were different degrees of calculated branching, with all items leading to more branching in the PE product than that of the pure PVC. The toy lizard and vinyl record produced PE materials with >50 branches per 1000 C, resulting in Tₘ's of 65 and 69, respectively. Rigid PVC pipe produced a PE product with 43 branches per 1000 C, leading to a higher Tₘ of 82. It is proposed that when the rigid PVC pipe contains a high percentage of additives by weight, the Et₃SiH loading exceeds 6 equivalents, which, as shown in FIG. 4, was previously demonstrated to reduce branching.

For comparison, PVC was extracted from the toy lizard and vinyl record, with additives separated, to identify if the additives influence the reaction. Upon using the same reaction conditions as FIG. 3, Entry 4, near-full dechlorination for both purified PVC items is observed. Notably, the vinyl record showed a slightly raised Tₘ measured by DSC (76 vs. 69° C.), yet the PVC extracted from the lizard showed a significantly higher Tₘ (83° C. vs. 65° C.) when compared to the product from the item directly. The product from the reaction with the extracted PVC from the lizard also showed a second thermal transition at 102° C., which could be due to the insolubility of the PVC until a few hours into the reaction. These data suggest that depending on the PVC item being dechlorinated, the final properties of the polymer can be greatly impacted by additives/plasticizers present.

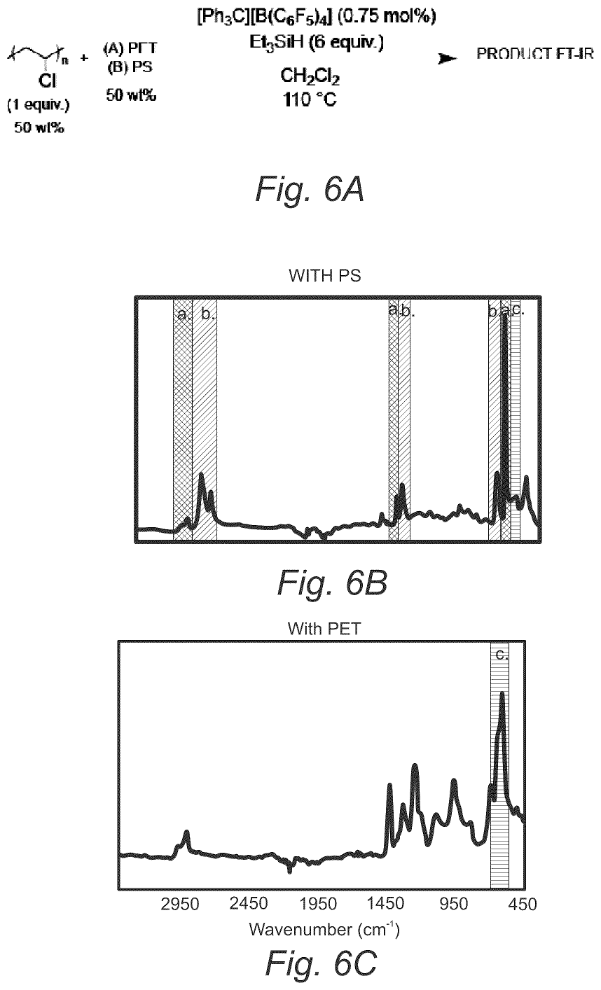

The dechlorination of PVC to PE in the presence of other plastics in was also pursued in an effort to simulate what would happen in a plastic waste stream (FIG. 6). Dechlorination of PVC was attempted in the presence of poly(ethylene terephthalate) (PET) or poly(styrene) (PS) to first test the compatibility of the reaction conditions with other plastics. The reaction in the presence of PET did not yield any dechlorination by FT-IR spectroscopy, which is proposed to be due to the high concentration of ester bonds in PET. This is surprising, as the method seemed to be robust for ester-containing plasticizers in commercial items. Dechlorination of PVC in the presence of PS yielded a very insoluble polymer product. FT-IR and ¹H NMR analysis indicate the presence of arenes in the polymer product, which supports cross-linking between the C—C backbone of the PVC chain and the phenyl rings on PS, yielding cross-linked PS. This can be possible due to Friedel-Crafts alkylation of the carbocations generated on the PVC backbone, supported by past silylium ion chemistry on small molecules and PVC. Nonetheless, FT-IR and ¹H NMR identify a significant loss of Cl in the presence of PS.

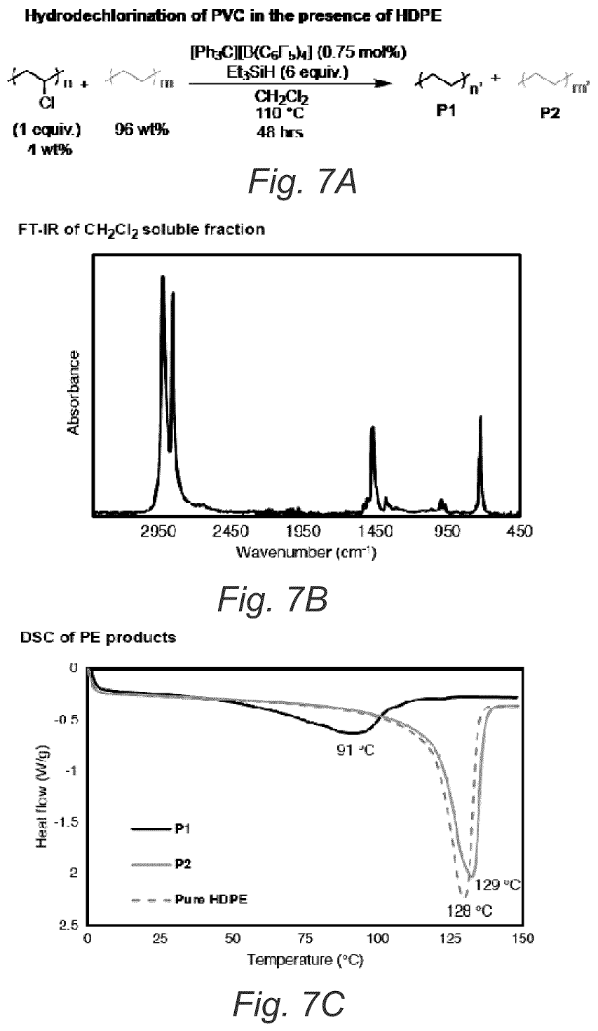

When dechlorination of PVC was attempted in the presence of PE (4 wt % of PVC, 96 wt % PE) to mimic the common impurity of PVC in PE waste, the reaction yielded near fully dechlorinated PVC (99.8% Cl loss by ¹H NMR) (FIG. 7). The reaction was performed in CH₂Cl₂, and the CH₂Cl₂ fraction was separated from the insoluble PE beads. The resulting CH₂Cl₂ fraction was purified (see SI for details), and the PE product was isolated in a 108% yield. In the reaction with pure PVC, a branching degree of 31 B/1000 C was observed and a Tₘ=84° C. (FIG. 3B, entry 4). The PE achieved from the dechlorination in the presence of excess PE had a branching content of 32 B/1000 C, but a Tₘ=91° C. A very minor thermal transition at 123° C. is also observed in this sample. Analysis by GPC indicates a molecular weight double of what is achieved from PVC by itself, further suggesting that some PE is undergoing cation transfer with the PVC chain. However, when the reaction conditions from FIG. 3 were replicated without the presence of HDPE beads, a higher molecular weight is also achieved (FIG. 3B, Entry 8). These data suggest that dilution can lead to less chain scission in the polymer chain. To probe whether the PE product and HDPE phase separates, PE from reaction FIG. 3B, entry 4 was analyzed by DSC in the presence of HDPE (83 wt % vs 17 wt %, respectively). The DSC trace shows two distinct melting points, with a Tₘ=84° C. and Tₘ=126° C. These data show that the products obtained from mixed PVC/PE waste are separable, leading to pure PE products with different thermal properties.

### 2.3 Conclusions

It has been demonstrated that PVC can be fully dechlorinated to PE within two hours by generating silylium ions in situ. By varying Et₃SiH concentration, the degree of branching, and therefore thermal properties, can be tuned of the resulting PE product. Importantly, this reaction is robust to common plasticizers and additives found in commercial PVC items, and full dechlorination can even occur in the presence of PE waste. This dechlorination strategy offers a controlled way of converting PVC contaminated PE waste to useful products that can be used for upcycled applications or also passed on to pyrolysis without the worry of corroding reactors, decomposing catalysts or altering the product distribution.

### 3. Synthesis and Properties of Poly(Vinyl Chloride)-b-Polyethylene Multiblock Copolymers

### 3.1 Results and Discussion

The first example of well-defined PVC-b-PE copolymers with a wide range of Cl percentages is presented below. These copolymers are achieved by the hydrodechlorination of waste PVC by silylium ions. This chemistry not only produces multiblock copolymers, but the block number can be tuned via reaction temperature (FIG. 8). This enables access to a wide range of PVC-b-PE copolymers with controllable Cl %, opening a promising class of chlorinated polymer materials that cannot be achieved with current synthetic methods. These new PVC-b-PE copolymers are shown to have remarkable interfacial adhesion of polyolefin elastomer (POE) and PVC films, demonstrating a potential use for these materials.

### 3.1.1 Initial Synthesis of PVC-b-PE Copolymers

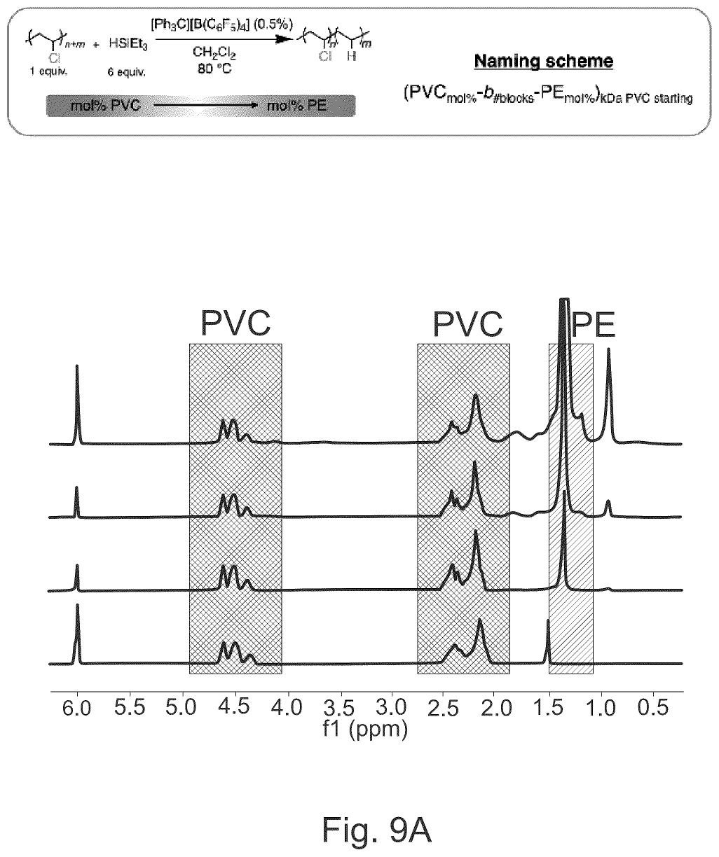

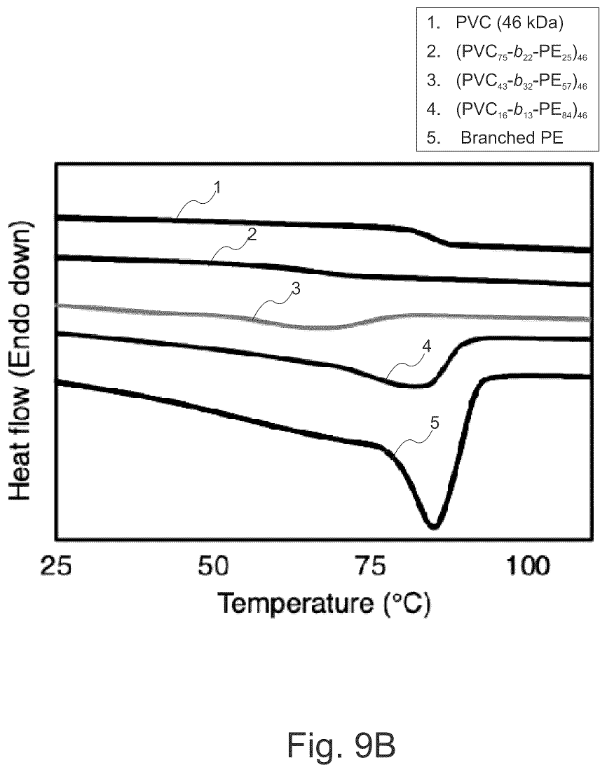

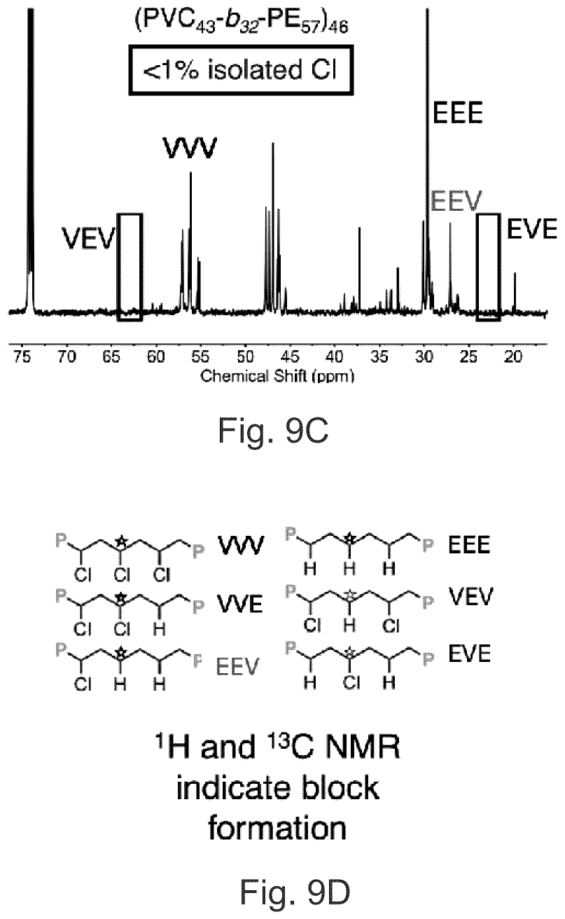

To achieve controlled multi-block copolymers of PVC-b-PE, the previously established dechlorination methodology was employed using silylium ion reagent and perfluoro borate catalyst. (37) Three samples of 25, 57, and 84 mol % PE were produced and analyzed by ¹³C and ¹H NMR spectroscopy (FIG. 9). For clarity, these samples will be labeled PVC (mol % PVC)-b (#blocks)-PE (mol % PE).

The ¹H NMR spectrum of PVC₄₃-b₃₂-PE₅₇ presents similar resonances to that measured for PVC and branched PE (FIG. 9A), in stark contrast to the random hydrodechlorination seen with Bu₃Sn·(32) (36) Diffusion ordered spectroscopy (DOSY) confirms that the PE and PVC units are in the same polymer chain.

Differential scanning calorimetry (DSC) was performed to probe crystallinity (FIG. 9B). PVC₇₆-b₂₂-PE₂₄ exhibits a glass transition (T_{g}) at 66° C., with no melting point observed, (8), (34) likely due to the short PE regions being unable to form crystalline domains. This T_{g} is lower than Differential scanning calorimetry (DSC) was performed to probe crystallinity (FIG. 9B). PVC76-b-22-PE24 exhibits a glass transition (T_{g}) at 66 □C, with no melting point observed, (8), (34) likely due to the short PE regions being unable to form crystalline domains. This T_{g} is lower than pure PVC (84° C.), which can be due to the short amorphous PE regions, which have a very low T_{g}, mixing with the PVC. PVC₄₃-b₃₂-PE₅₇ displays a 66° C. melting point (Tₘ), which is lower than the fully dechlorinated sample synthesized under the same conditions (84° C.) and is 89% less crystalline. PVC₉-b₈-PE₉₁ exhibits a broad Tₘ at 85° C., matching the fully hydrodechlorinated sample with similar branching, and is 79% as crystalline. (34)

### 3.1.2 NMR Spectroscopy Analysis

¹³C NMR spectroscopy is especially powerful to determine the block structure of the polymers, as it reveals the triad units that can be present (FIGS. 9C and 9D). (9), (34) If PVC were randomly hydrodechlorinated, then a high percentage vinyl-ethylene-vinyl (VEV) units would be expected, as compared to EEE. When PVC is hydrodechlorinated by silylium ions, however, <1% of VEV triads are observed (FIGS. 9C and 9D), highlighting the formation of PVC-b-PE copolymers. EEV and VVE triads exist at the transition between PVC and PE blocks and were used to calculate the number of PVC and PE blocks. HSQC experiments were applied to identify the corresponding transition feature in the ¹H NMR spectrum, accelerating these measurements.

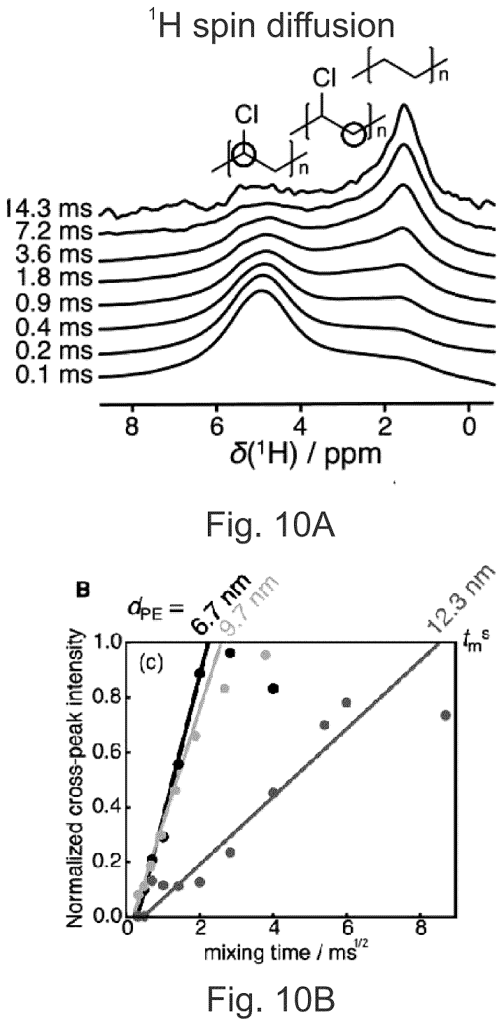

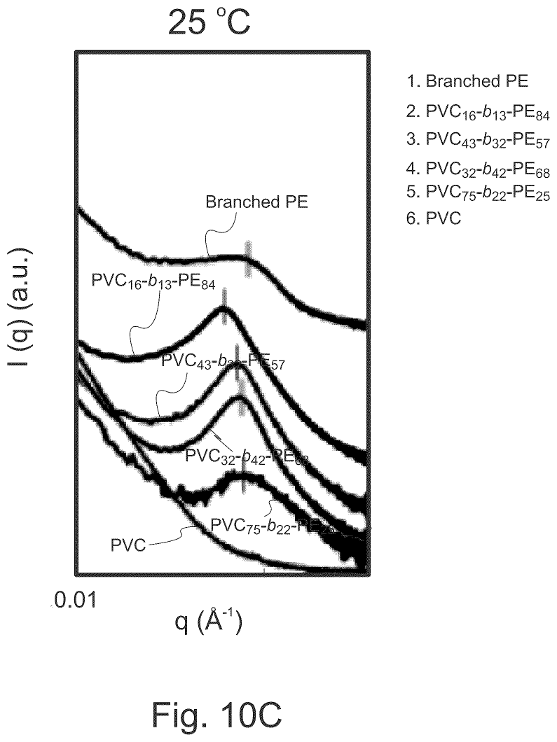

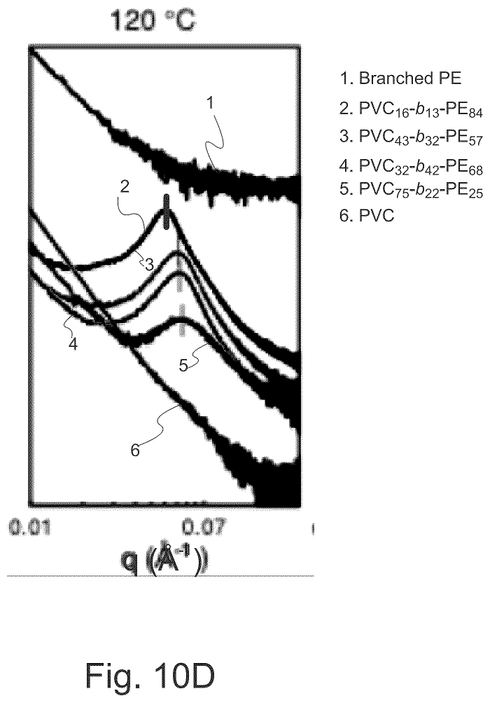

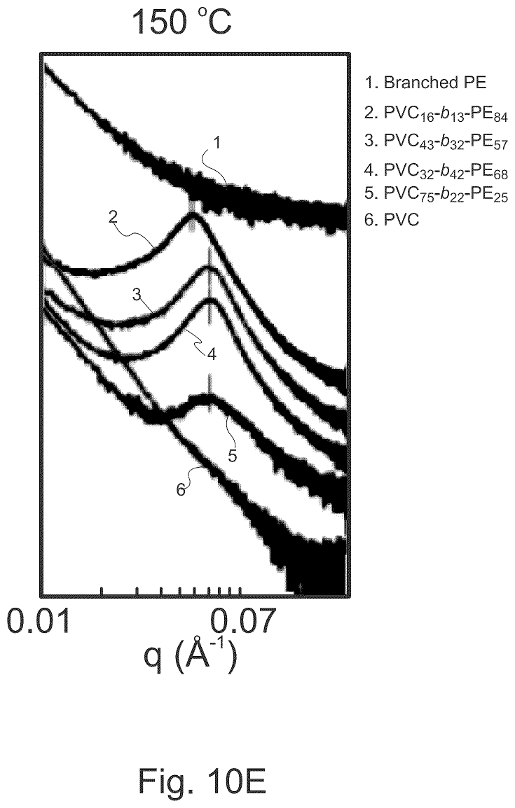

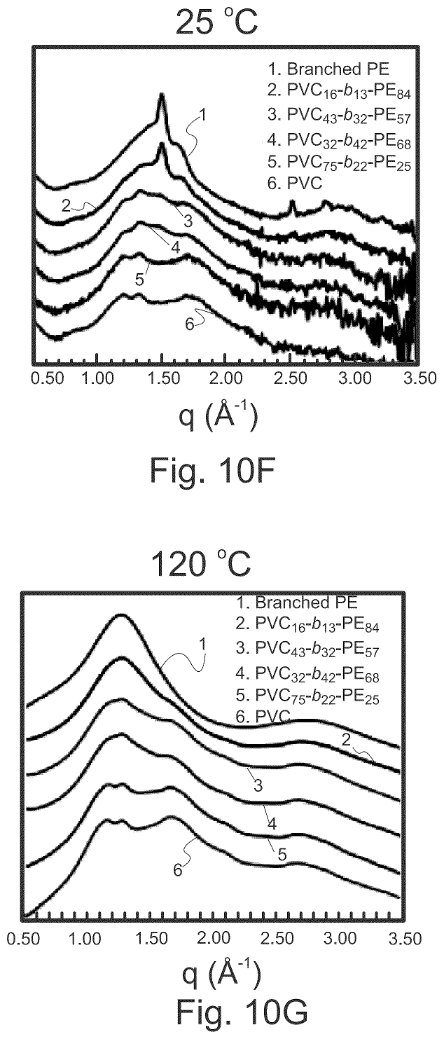

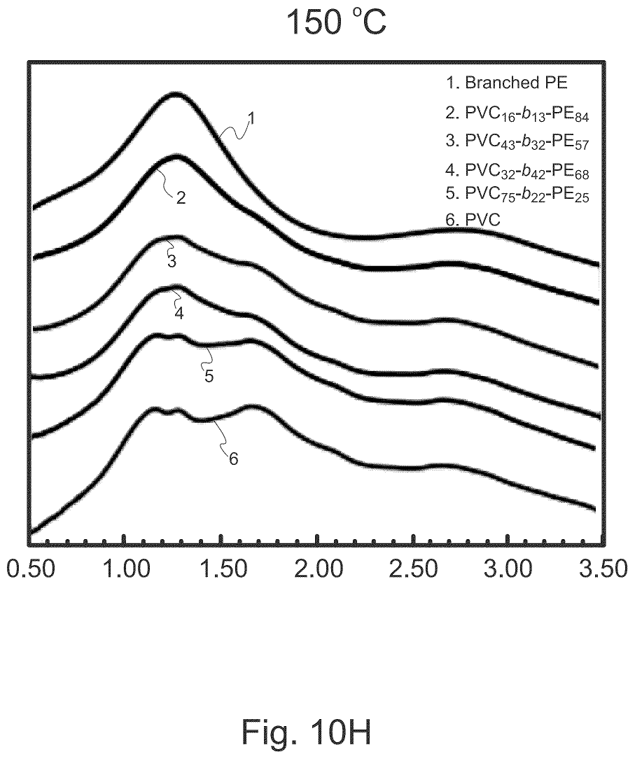

¹H spin diffusion between the PVC and PE blocks was measured in the solid state to probe domain formation and size (FIGS. 10A and 10B). (38) Assuming a spin diffusion coefficient of 0.2 nm² ms⁻¹, PE lamella sizes of 6.7, 9.7, and 12.3 nm for PVC₇₅-b₂₂-PE₂₅, PVC₄₃-b₃₂-PE₅₇, and PVC₁₆-b₁₃-PE₈₄ were, respectively measured, suggesting that the PE domain sizes increased with the PE concentration, in agreement with the scattering measurements, vide infra.

### 3.1.3 WAXS/SAXS Analysis

Wide-angle X-ray scattering (WAXS) was conducted to further characterize the crystalline PE regions of PVC-b-PE (FIGS. 10C, 10D, and 10E). In agreement with DSC, PVC₄₃-b₃₂-PE₅₇ displays low amounts of PE crystallinity. This is represented by a small peak at ˜1.5 Å⁻¹ in the WAXS spectra that is more apparent in the 19 and <1% PVC samples. The absence of a very sharp peak in this region matching the <1% PVC sample suggests that polymers are multiblock rather than diblock copolymers.

Small-angle X-ray scattering (SAXS) was conducted to identify the micro-phase separation (FIGS. 10F, 10G, and 10H) of the block copolymers. While amorphous PVC shows no signal, fully dechlorinated PVC shows a broad SAXS peak. The peak is situated at a relatively high q value (0.06 Å⁻¹), compared to the HDPE, further confirming the significant branching of PE chains as reported previously, due to carbocation rearrangements. (39) In this case, the majority of branches are methyl. Above the Tₘ, the fully dechlorinated PVC does not show a SAXS peak, confirming the peak to be due to the crystalline lamella of PE. Partially dechlorinated samples all show a SAXS peak that persists above Tₘ, suggesting that they originate from the phase separation of PE and PVC and not from the crystalline lamella of PE. The peaks from partially dechlorinated samples are situated at a relatively lower q value (0.06 Å⁻¹) or larger d-spacing compared to the fully dechlorinated sample. This indicates that the partially dechlorinated samples are strongly segregated block copolymer systems. If the energetic gain due to crystallization is stronger than that from micro-phase separation, the SAXS peak at a lower temperature than Tₘ would appear at significantly lower q values than those at a temperature above Tₘ.

### 3.1.4 Variation of Block Number

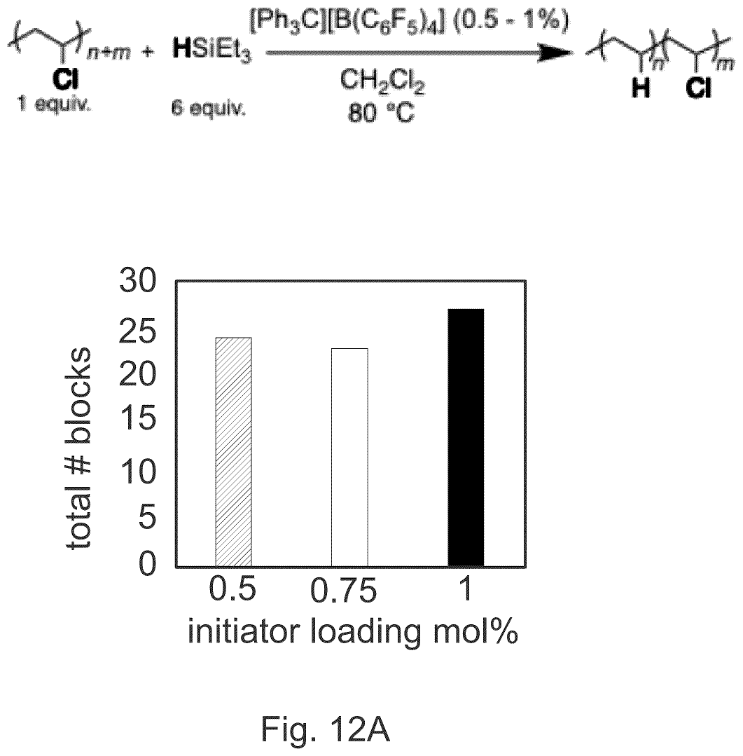

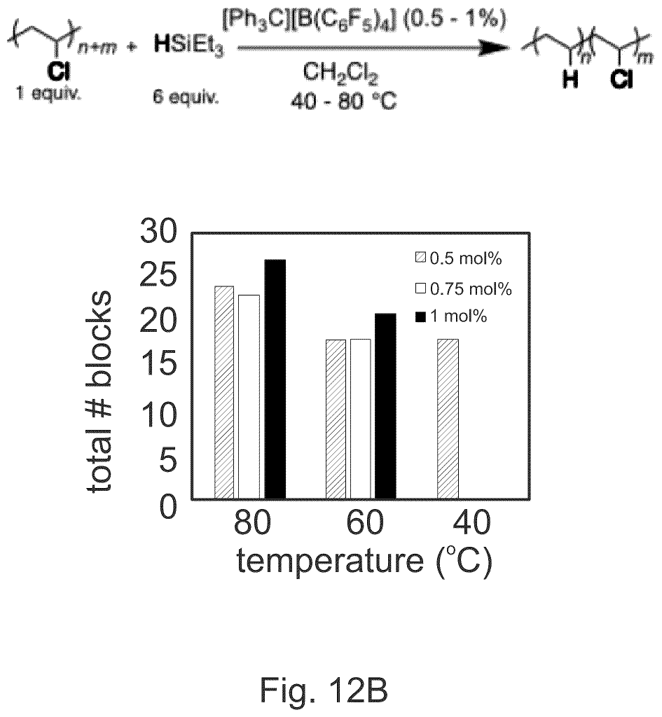

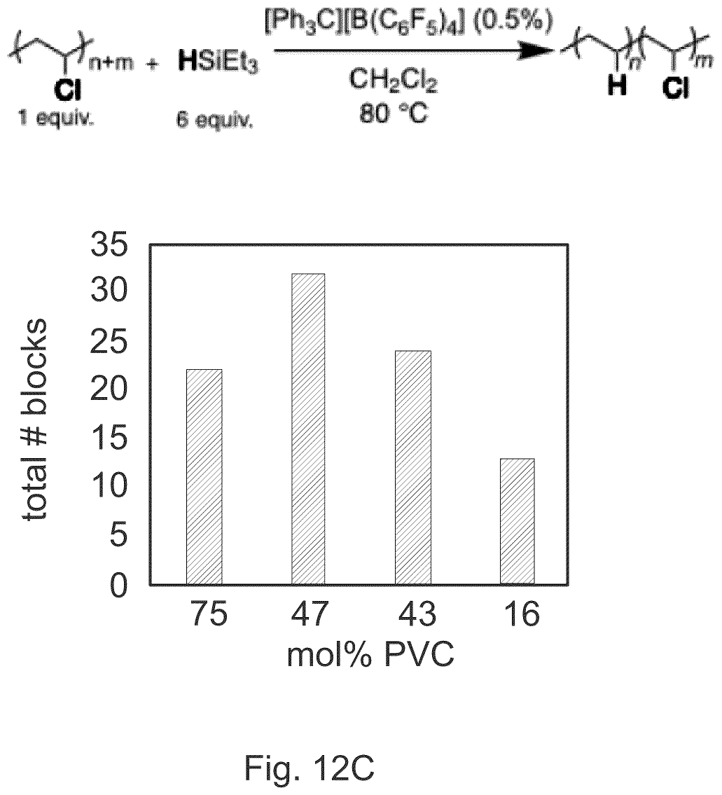

Control of the number of blocks was attempted by varying the initiator ([CPh₃][B (C₆F₅)₄]) loading from 0.5 to 0.75 to 1.0 mol % (relative to PVC). (FIG. 12A). However, the number of blocks stayed relatively consistent between the chosen initiator loadings at 80° C. This was surprising, as it was expected that the number of blocks would be proportional to the number of silylium ions per polymer chain. Referring to FIGS. 12B and 12C, however, see a decrease in the number of blocks when the temperature is lowered to 60° C. and 40° C., indicating that both the block lengths and % Cl are independently controllable.

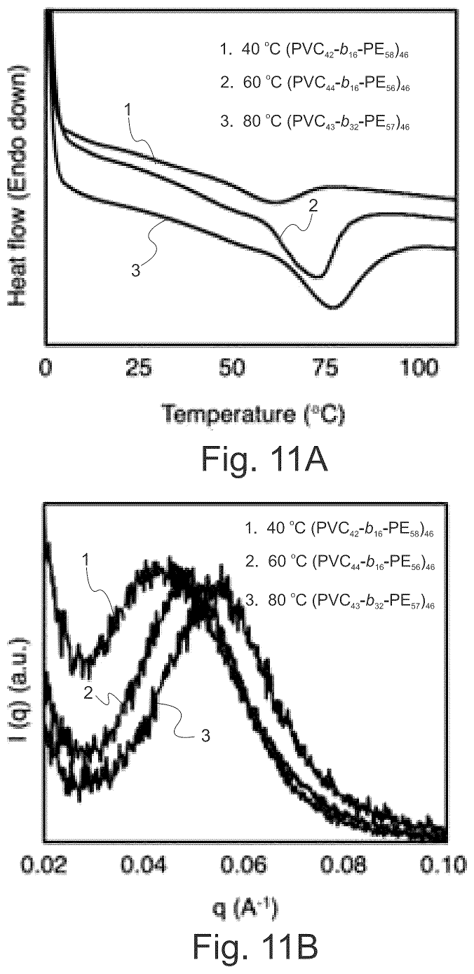

Comparison of PVC₄₇-b₂₄-PE₅₃ and PVC₄₂-b₁₆-PE₅₈ by DSC reveals that fewer blocks raise the Tₘ (60 to 77° C.) (FIG. 11A) and the crystallinity (by 287%), which agrees with the hypothesis that longer PE regions lead to higher crystallinity. SAXS spectra acquired for the PVC-b-PE copolymers synthesized at 40° C. have lower q values than those synthesized at 80° C. (0.40-0.50 Å⁻¹ vs. 0.50-0.60 Å⁻¹, FIG. 11B), in agreement with the reduction in block lengths and with the spin diffusion experiments.

FIG. 12C provides a bar chart showing the number of blocks versus mol % PVC. The number of blocks initially increases as the PVC is increased from 16 mol %. After peaking at about 47 mol %, the number of blocks decreases.

### 3.1.5 Compatibilization Testing

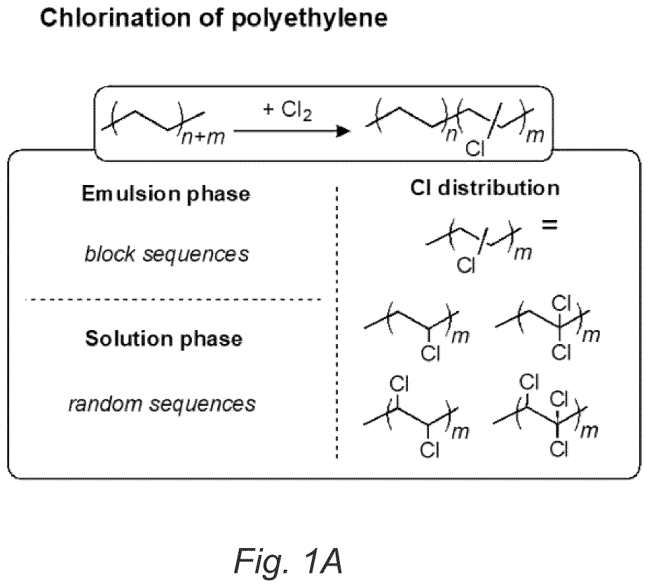

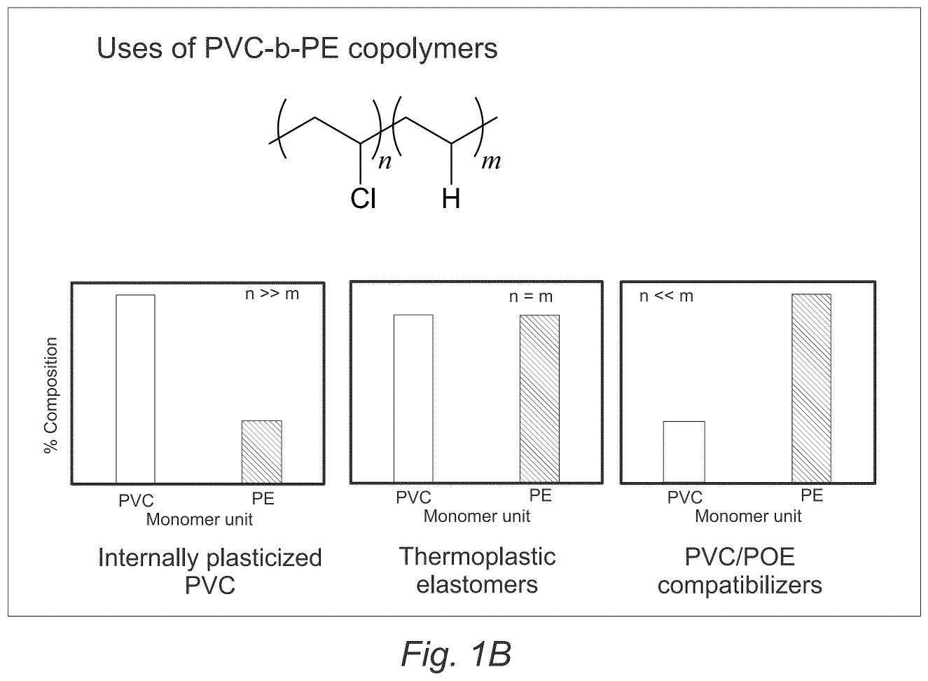

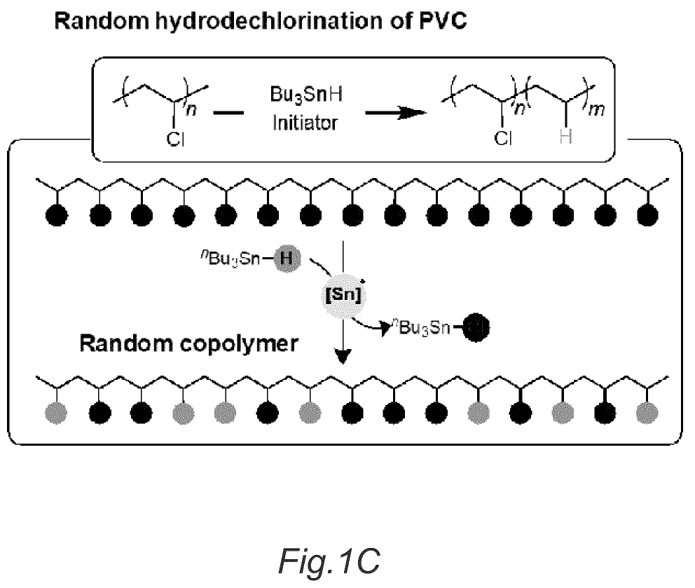

One use of blocky CPE has been as a PE/PVC compatibilizer. (14), (42)-(44) PVC by itself is very brittle and has poor impact resistance; blending it with more elastic polyolefins can mitigate this issue. Theoretical studies have suggested that as the number of effective crossings of a copolymer at the interface, a function of the number of blocks determines its adhesion capability, (45) which has been also shown experimentally for polystyrene/poly(2-vinylpyridine), and polyethylene/polypropylene interfaces. (45) While multiblock copolymers of CPE are good interfacial modifiers for PVC/polyolefin blends, the primary structure of the chlorinated parts of CPE is not PVC (FIG. 1A). Additionally, high C1% are difficult to achieve without losing the multiblock units. Therefore, it was hypothesized that the PVC-b-PE may be superior compatibilizers.

To evaluate this hypothesis, interfacial adhesion of PVC/POE interfaces with PVC-b-PE was performed with a peel test. Interfacial adhesion (Ga) was measured for each PVC-b-PE copolymer in multiple trials. All PVC-b-PE copolymers significantly improve the interfacial adhesion of PVC/POE, with a decrease at the lowest % Cl; PVC₂₈-b₂₅-PE₇₂ is the best performing compatibilizer (Gₐ=6289 J/m²). Although this material was prepared with a different solvent than CPE, this material outperforms the best performing multiblock CPE compatibilizer (˜80% PE density, Gₐ=5090 J/m²), (14) supporting the hypothesis that retaining the PVC and PE block structures can be very important for material properties, especially interfacial compatibilizers.

### 3.2 Conclusion

The synthesis of controlled PVC-b-PE copolymers was achieved by the dechlorination of PVC with silylium ions. Unlike CPE copolymers, PVC-b-PE retains the primary repeating unit structure of PVC and can readily access PVC percentages above 60%. 1H and 13C NMR analysis indicated the PVC-b-PE copolymers were multiblock, and that the number of blocks varied based on dechlorination percentage and reaction temperature. These multiblock copolymers exhibit excellent PVC/PE compatibilization properties, outperforming both block and random CPE.

### 3.3 Experimental Procedures

### 3.3.1 General Considerations

All reactions were performed on the benchtop with no further purification of reagents unless otherwise noted. Poly(vinyl chloride) (PVC) (Aldrich, low molecular weight, Product #: 81388; Mₙ=35 kg/mol, M_{w}=62 kg/mol, Product #: 189588; Mₙ=47 kg/mol, M_{w}=80 kg/mol, Product #: 389232; Mₙ=99 kg/mol, M_{w}=233 kg/mol, Product #: 346764) were used as received. Triphenylmethylium terakis (pentaflouorophenyl) borate ([Ph₃C][B (C₆F₅)₄]) was purchased from Fischer Chemical (Fisher, Product #: T28635G) and anhydrous grade triethyl silane (Et₃SiH) (Aldrich. Product #: 230197) was purchased from Aldrich and used as received. ([Ph₃C][B (C₆F₅)₄]) stored in a glove box under an N₂ atmosphere and transferred to a desiccator 1 hour—14 days prior to use. Et₃SiH was stored in under atmospheric conditions. CDCl₃ was purchased from Cambridge Isotope Laboratories and tetrachloroethane-d₂ (Cl₂CDCDCl₂) was purchased from Fischer Chemical.

### 3.3.2 Methods

NMR Spectroscopy: ¹H and ¹³C {¹H} NMR spectra from USC were recorded on a Varian 500-MR 2-Channel NMR spectrometer or Varian VNMRS-600 3-Channel NMR spectrometer.

Solid State NMR Spectroscopy: Relative polyethylene domain sizes in partially dechlorinated PVC polymers were investigated using ¹H-detected fpRFDR experiments. All experiments were performed using a Bruker AVANCE III 600 MHz NMR spectrometer equipped with a 1.6 mm MAS probe and MAS frequencies of 40 kHz. Spectra were acquired using recycle delays set to 1.3T₁ (about 2s) in 8 scans and 512 ti increments of 125 μs. All pulses had radiofrequency powers of 100 kHz and the recoupling time was varied from 0.1 to 64 ms. Signals were deconvoluted using DMfit.

Gel Permeation Chromatography (GPC): Polymer molar masses and dispersities for PVC-b-PE materials were determined using a SEC-MALS instrument equipped with an Agilent 1260 Infinity II HPLC System and autosampler, 2 Agilent PolyPore columns (both 5 micron, 4.6 mm ID) in sequence, a Wyatt DAWN HELEOS-II light scattering detector, and a Wyatt Optilab TrEX refractive index detector. The columns were eluted with HPLC grade THF at 30° C. at a flow rate of 0.3 mL/min, and polymer samples were dissolved in this solvent and filtered through a 0.2 micron PTFE membrane before SEC-MALS (size exclusion chromatography multi-angle light scattering) analyses. Dn/dc values were calculated from the RI signal by using the 100% mass recovery method in the Astra software and a known sample concentration.

Differential Scanning calorimetry (DSC): DSC traces were recorded using a TA Instruments Discovery DSC 250 Auto, equipped with a Discovery LN Pump, and processed with TRIOS software. The DSC measurements were made at a heating rate of 10° C./min and N₂ flow rate of 20 ml/min, and Tₘ values were obtained from the melting transition in the second heating curve.

### 3.3.3 Additional Discussion

¹H Spin Diffusion Measurements: Estimations of the domain sizes can be obtained using ¹H spin diffusion measurements using solid-state NMR spectroscopy. Generally, magnetization is first initiated on a given block using frequency selection, and this magnetization is then left to diffuse to other blocks, where it is subsequently detected. We achieved this using a 2D ¹H finite-pulse radiofrequency-driven recoupling (fpRFDR) 2D correlation experiment, looking at the build-up of the cross-peak originating from spin diffusion from the PVC methyne to the PE domains. As described elsewhere, the spin diffusion build-up curves may be normalized to their plateau values, as determined by the relative ratios of PE and PVC. This normalized exchange intensity is then plotted as a function of the square root of the mixing time (tₘ^{1/2}) and the extrapolated intercept at 100% exchange, denoted tₘ^{s} can be used to determine lamella size. The relationship between the lamella size (d_{A}) and tₘ^{s} is given by:

$${d}_{A} = \frac{\sqrt{4 {Dt}_{m}^{s} / π}}{1 - {f}_{A}}$$

where D is the spin diffusion coefficient and fa of the fraction of the polymer consisting of block A. Experimental values for D typically range from 0.8 to 0.1 nm² ms⁻¹. Although we do not have an experimental measurement of D for PE-PVC block copolymers under fpRFDR recoupling, a value of 0.2 nm² ms⁻¹ yields domain sizes that are comparable to those determined using SAXS and as such this value was used.

### 3.3.4 General Procedures for PVC-b-PE Synthesis

([Ph₃C][B(C₆F₅)₄]) (36.9 mg, 0.40 mmol, 0.5 mol %), Et₃SiH (7.67 mL, 48 mmol, 6 equiv.), CH₂Cl₂ (5 mL), and a stir bar were charged to a 2 dram vial. The vial was then stirred for 5 minutes. PVC (500 mg, 8 mmol, 1 equiv.) was weighed into a 30 mL Chemglass heavy wall pressure vessel, and 27 mL of CH₂Cl₂ was added. The ([Ph₃C][B (C₆F₅)₄])/CH₂Cl₂ mixture was then added to the PVC before the pressure vessel was placed inside an oil bath that was preheated to 40-80° C. After desired reaction time, the reaction mixture was quenched with methanol (˜15 mL), which resulted in the precipitation of white solids. The mixture was then filtered and washed with methanol (˜5 mL) three times. The polymer was then dried at 60° C. for 18 hours.

Yield of polyethylene products were calculated as follows in Equation 1.1:

$$Equation 1.1 . \% Yield = \frac{experimental mass}{m mol ( PE ) * ( {MW}_{PE} ) + mmol ( PVC ) * ( {MW}_{PVC} )} * 100$$

$$\# of Blocks using Equation 5.2 :$$

$$Equation 1.2 = \frac{( Integration PVC methine VVE )}{( Integration PVC methine VVE + VVV )} * mol \% PVC * \# repeat units$$

% Cl loss calculated using Equation 5.3:

$$Equation 1.3 . \% Cl loss = 100 - \frac{integration 4 - 4.5 ppm}{( \frac{integration 1 - 1.5 ppm}{4} )} * 100$$

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

1. S. Xu, Z. Han, K. Yuan, P. Qin, W. Zhao, T. Lin, T. Zhou, F. Huang, Upcycling chlorinated waste plastics. Nat Rev Methods Primers 3, 44 (2023).
2. D. Braun, PVC—origin, growth, and future. Vinyl Additive Technology 7, 168-176 (2001).
3. E. Boz, K. B. Wagener, Progress in the Development of Well-Defined Ethylene-Vinyl Halide Polymers. Polymer Reviews 47, 511-541 (2007).
4. R. Geyer, J. R. Jambeck, K. L. Law, Production, use, and fate of all plastics ever made. Science Advances 3, e1700782 (2017).
5. E. Boz, A. J. Nemeth, I. Ghiviriga, K. Jeon, R. G. Alamo, K. B. Wagener, Precision Ethylene/Vinyl Chloride Polymers via Condensation Polymerization. Macromolecules 40, 6545-6551 (2007).
6. K. Friese, B. Höβelbarth, J. Reinhardt, R. Newe, A novel process for the chlorination of polymers in solution. Angew. Makromol. Chem. 234, 119-132 (1996).
7. B. H. Chang, J. W. Dai, A. Siegmann, A. Hiltner, Chlorinated high density polyethylene. II. Solid state structure. Polymer Engineering & Sci 28, 1173-1181 (1988).
8. J. Sobottka, Glass transitions and secondary transitions in chlorinated poly(ethylenes). Acta Polymerica 34, 647-650 (1983).
9. T. Saito, Y. Matsumura, S. Hayashi, High-Resolution NMR Study of Chlorinated Polyethylenes. Polym J 1, 639-655 (1970).
10. T. N. Bowmer, A. E. Tonelli, Thermal transitions of ethylene-vinyl chloride copolymers. Polymer 26, 1195-1201 (1985).
11. R. J. Hanna, J. W. Fields, Vinyl chloride-ethylene copolymers: The effect of modest ethylene concentrations on the physical properties of compounds. J. Vinyl Addit. Technol. 4, 57-61 (1982).
12. F. H. Schacher, P. A. Rupar, I. Manners, Functional Block Copolymers: Nanostructured Materials with Emerging Applications. Angew Chem Int Ed 51, 7898-7921 (2012).
13. T. C. Chung, Synthesis of functional polyole®n copolymers with graft and block structures. Prog. Polym. Sci. (2002).
14. E. A. Eastwood, M. D. Dadmun, Compatibilization of poly(vinyl chloride) and polyolefin elastomer blends with multiblock/blocky chlorinated polyethylenes. Polymer 43, 6707-6717 (2002).
15. E. O. Khakberdiev, Q. N. U. Berdinazarov, D. A. U. Toshmamatov, N. R. Ashurov, Mechanical and morphological properties of poly(vinyl chloride) and linear LOW-DENSITY polyethylene polymer blends. Vinyl Additive Technology 28, 659-666 (2022).
16. H. W. Boone, P. S. Athey, M. J. Mullins, D. Philipp, R. Muller, W. A. Goddard, Copolymerization Studies of Vinyl Chloride and Vinyl Acetate with Ethylene Using a Transition-Metal Catalyst. J. Am. Chem. Soc. 124, 8790-8791 (2002).
17. L. S. Boffa, B. M. Novak, Copolymerization of Polar Monomers with Olefins Using Transition-Metal Complexes. Chem. Rev. 100, 1479-1494 (2000).
18. S. Svadlenak, S. Wojcik, O. Ogunlalu, M. Vu, M. Dor, B. W. Boudouris, D. Wildenschild, K. A. Goulas, Upcycling of polyvinyl chloride to hydrocarbon waxes via dechlorination and catalytic hydrogenation. Applied Catalysis B: Environmental 338, 123065 (2023).
19. P. A. Kots, B. C. Vance, C. M. Quinn, C. Wang, D. G. Vlachos, A two-stage strategy for upcycling chlorine-contaminated plastic waste. Nat Sustain, doi: 10.1038/s41893-023-01147-z (2023).
20. Q. Zhou, C. Tang, Y.-Z. Wang, L. Zheng, Catalytic degradation and dechlorination of PVC-containing mixed plastics via Al—Mg composite oxide catalysts. Fuel 83, 1727-1732 (2004).
21. T. Bhaskar, R. Negoro, A. Muto, Y. Sakata, Prevention of chlorinated hydrocarbons formation during pyrolysis of PVC or PVDC mixed plastics. Green Chem. 8, 697 (2006).
22. K.-B. Park, S.-J. Oh, G. Begum, J.-S. Kim, Production of clean oil with low levels of chlorine and olefins in a continuous two-stage pyrolysis of a mixture of waste low-density polyethylene and polyvinyl chloride. Energy 157, 402-411 (2018).
23. T. Okada, S. Sutoh, K. Sejima, H. Tomohara, S. Mishima, A useful method for thorough dehydrochlorination of Poly(vinylidene chloride-co-vinyl chloride) using Zinc (II) oxide. Polymer Degradation and Stability 171, 109040 (2020).
24. A. Marino, A. Aloise, H. Hernando, J. Fermoso, D. Cozza, E. Giglio, M. Migliori, P. Pizarro, G. Giordano, D. P. Serrano, ZSM-5 zeolites performance assessment in catalytic pyrolysis of PVC-containing real WEEE plastic wastes. Catalysis Today 390-391, 210-220 (2022).
25. L. Guo, G. Shi, Y. Liang, Poly(ethylene glycol) s catalyzed homogeneous dehydrochlorination of poly(vinyl chloride) with potassium hydroxide. Polymer 42, 5581-5587 (2001).
26. Y. Chen, S. Zhang, X. Han, X. Zhang, M. Yi, S. Yang, D. Yu, W. Liu, Catalytic Dechlorination and Charring Reaction of Polyvinyl Chloride by CuAl Layered Double Hydroxide. Energy Fuels (2018).
27. P. Zhao, The study of nickel effect on the hydrothermal dechlorination of PVC. Journal of Cleaner Production (2017).
28 G. O'Rourke, T. Hennebel, M. Stalpaert, A. Skorynina, A. Bugaev, K. Janssens, L. Van Emelen, V. Lemmens, R. De Oliveira Silva, C. Colemonts, P. Gabriels, D. Sakellariou, D. De Vos, Catalytic tandem dehydrochlorination-hydrogenation of PVC towards valorisation of chlorinated plastic waste. Chem. Sci., 10.1039.D3SC00945A (2023).
29 G. O'Rourke, A. Skorynina, I. Beckers, S. Van Minnebruggen, C. Colemonts, P. Gabriels, P. Van Der Veken, D. De Vos, Conversion of diverse post-consumer PVC waste materials to PE via dual catalytic tandem dehydrochlorination-hydrogenation. EES. Catal., 10.1039.D4EY00082J (2024).
30. N. G. Bush, M. K. Assefa, S. Bac, S. Mallikarjun Sharada, M. E. Fieser, Controlling selectivity for dechlorination of poly(vinyl chloride) with (xantphos) RhCl. Mater. Horiz. 10, 2047-2052 (2023).
31. A. T. Normand, Y. Wu, T. Régnier, P. Fleurat-Lessard, Y. Rousselin, B. Théron, P. Le Gendre, M. Carta, Poly(vinyl chloride) Dechlorination Catalyzed by Zirconium. Chemistry A European J, e202304005 (2024).
32. F. A. Jameison, F. C. Schilling, A. E. Tonelli, Tri-. eta.-butyltin hydride reduction of poly(vinyl chloride): kinetics of dechlorination for 2,4-dichloropentane and 2,4,6-trichloroheptane. Macromolecules 19, 2168-2173 (1986).
33. D. Braun, W. Mao, B. Böhringer, R. W. Garbella, Preparation of vinyl chloride-ethylene copolymers by partial reduction of poly(vinyl chloride). Angew. Makromol. Chemie 141, 113-129 (1986).
34 N. Pourahmady, P. I. Bak, R. A. Kinsey, Microstructure and Thermal Properties of Ethylene/Vinyl Chloride Copolymers. Journal of Macromolecular Science, Part A 29, 959-974 (1992).
35 M. A. Gomez, A. E. Tonelli, A. J. Lovinger, F. C. Schilling, M. H. Cozine, D. D. Davis, Structure and morphology of ethylene-vinyl chloride copolymers. Macromolecules 22, 4441-4451 (1989).
36. R. E. Cais, M. Kometani, Ethylene-vinyl bromide copolymers by reductive debromination of poly(vinyl bromide). A carbon-13 NMR study. Macromolecules 15, 954-960 (1982).
37. Z. A. Wood, E. C. Castro, A. N. Nguyen, M. E. Fieser, Conversion of waste poly(vinyl chloride) to branched polyethylene mediated by silylium ions. Chem. Sci. 15, 8766-8774 (2024).
38. J. Clauss, K. Schmidt-Rohr, H. W. Spiess, Determination of domain sizes in heterogeneous polymers by solid-state NMR. Acta Polymerica 44, 1-17 (1993).
39. K. Tashiro, M. M. Satkowski, R. S. Stein, Y. Li, B. Chu, S. L. Hsu, Cocrystallization and phase segregation of polyethylene blends. 2. Synchrotron-sourced x-ray scattering and small-angle light scattering study of the blends between the D and H species. Macromolecules 25, 1809-1815 (1992).
40. S. D. Smith, R. J. Spontak, M. M. Satkowski, A. Ashraf, J. S. Lin, Microdomain contraction in microphase-separated multiblock copolymers. Phys. Rev. B 47, 14555-14558 (1993).
41. R. J. Spontak, S. D. Smith, Perfectly-alternating linear (AB) n multiblock copolymers: Effect of molecular design on morphology and properties. J Polym Sci B Polym Phys 39, 947-955 (2001).
42. Y.-D. Lee, C.-M. Chen, Properties of PVC/CPE/EPDM polyblends. J. Appl. Polym. Sci. 33, 1231-1240 (1987).
43. P. He, H. Huang, W. Xiao, S. Huang, S. Cheng, A study on PVC/LLDPE blends with solid-state-chlorinated polyethylene as compatibilizer. J. Appl. Polym. Sci. 64, 2535-2541 (1997).
44. X. Xi, M. Xiande, C. Keqiang, A study on poly(vinyl chloride) blends with chlorinated polyethylene and polyethylene. Polymer Engineering & Sci 27, 391-397 (1987).
45. M. Dadmun, Effect of Copolymer Architecture on the Interfacial Structure and Miscibility of a Ternary Polymer Blend Containing a Copolymer and Two Homopolymers. Macromolecules 29, 3868-3874 (1996).

What is claimed is:

1. A block copolymer comprising a polymer block structure including:
a plurality of chlorinated blocks present in a first molar percent; and
a plurality of polyethylene blocks present in a second molar percent,
wherein the polymer block structure includes at least 3 polymer blocks.

2. The block copolymer of claim 1, wherein the plurality of chlorinated blocks include poly(vinyl chloride) blocks.

3. The block copolymer of claim 1, wherein the sum of the first molar percent and the first molar percent is from about 98 to 100 mol %.

4. The block copolymer of claim 1, wherein the block copolymer includes at least 5 alternating blocks of chlorinated blocks and polyethylene blocks.

5. The block copolymer of claim 1, wherein the block copolymer includes from 5 to 100 alternating blocks of chlorinated blocks and polyethylene blocks.

6. The block copolymer of claim 1, wherein the first molar percent is from 10 to 90 molar percent.

7. The block copolymer of claim 1, wherein the first molar percent is from 10 to 50 molar percent.

8. The block copolymer of claim 1, further comprising residues of a cation initiator and/or an organosilane percent each present in an amount of less than 1 molar percent.

9. A poly(vinyl chloride)-b-polyethylene copolymer comprising a polymer block structure including:
a plurality of poly(vinyl chloride) blocks present in a first molar percent; and
a plurality of polyethylene blocks present in a second molar percent,
wherein the polymer block structure includes at least 3 polymer blocks.

10. The poly(vinyl chloride)-b-polyethylene copolymer of claim 9, wherein the poly(vinyl chloride)-b-polyethylene copolymer includes at least 5 alternating blocks of poly(vinyl chloride) and polyethylene blocks.

11. The poly(vinyl chloride)-b-polyethylene copolymer of claim 9, wherein the poly(vinyl chloride)-b-polyethylene copolymer includes from 5 to 100 alternating blocks of poly(vinyl chloride) and polyethylene blocks.

12. The poly(vinyl chloride)-b-polyethylene copolymer of claim 9, wherein the first molar percent is from 10 to 90 mol percent.

13. The poly(vinyl chloride)-b-polyethylene copolymer of claim 9, further comprising residues of a cation initiator and/or an organosilane.

14. A method for dechlorinating a starting chlorinated polymer, the method comprising:
contacting the starting chlorinated polymer with a solution that includes a cation initiator, an organosilane, and chlorinated solvent at a predetermined reaction temperature for a sufficient time to at least partially dechlorinate the starting chlorinated polymer to form a dechlorinated polymer.

15. The method of claim 14 further comprising a step of quenching the reaction and drying the dechlorinated polymer.

16. The method of claim 14, wherein a molar ratio of the organosilane to the starting chlorinated polymer is from 0.1 to 15.

17. The method of claim 14, wherein the cation initiator is present in an amount from about 0.1-5 mol % of a sum of the cation initiator, the starting chlorinated polymer, and the organosilane.

18. The method of claim 14, wherein the starting chlorinated polymer is completely dechlorinated.

19. The method of claim 14, wherein the starting chlorinated polymer is partially dechlorinated.

20. The method of claim 14, wherein the starting chlorinated polymer is a chlorinated polyolefin.

21. The method of claim 14, wherein the starting chlorinated polymer is polyvinylchloride.

22. The method of claim 21, wherein the starting chlorinated polymer is partially dechlorinated to form a block copolymer of polyethylene and polyvinylchloride.

23. The method of claim 14, wherein the cation initiator is [Ph₃C][B (C₆F₅)₄].

24. The method of claim 14, wherein the organosilane is a trialkylsilyl hydride.

25. The method of claim 14, wherein the organosilane is Et₃SiH.

26. The method of claim 14, wherein the chlorinated solvent is CH₂Cl₂.

27. The method of claim 14, wherein the predetermined reaction temperature is from 20 to 120° C.

28. The method of claim 14, wherein the sufficient time is at least 10 minutes.

29. The method of claim 14, wherein the sufficient time is at least 1 hour.

30. The method of claim 14, wherein the sufficient time is from 10 minutes to 24 hours or more.
